(19) United States
(12) Patent Application Publication
(10) Pub. No.: US 2025/0046499 A1
(43) Pub. Date: Feb. 6, 2025

(54) COMPOSITION, MAGNETIC MATERIAL AND ELECTRONIC COMPONENT

(71) Applicant: FUJIFILM Corporation, Tokyo (JP)

(72) Inventor: Tetsushi MIYATA, Shizuoka (JP)

(73) Assignee: FUJIFILM Corporation, Tokyo (JP)

(21) Appl. No.: 18/899,953

(22) Filed: Sep. 27, 2024

Related U.S. Application Data
(63) Continuation of application No. PCT/JP2023/008850, filed on Mar. 8, 2023.

(30) Foreign Application Priority Data
Mar. 31, 2022 (JP) 2022-059236

(51) Int. Cl. H01F 1/36

(52) U.S. Cl. CPC H01F 1/36; C01P 2004/32

(57) ABSTRACT

A first object of the present invention is to provide a composition with which a magnetic material having excellent magnetic permeability and moisture resistance can be formed. A second object of the present invention is to provide a magnetic material and an electronic component.

The composition of the present invention contains magnetic particles, a heterocyclic ring-containing compound, a compound selected from the group consisting of an epoxy compound and an oxetane compound, and a dispersant, in which a polarity element of a Hansen solubility parameter of the heterocyclic ring-containing compound is 8.0 MPa^{1/2} or more, and a hydrogen bond element of the Hansen solubility parameter of the heterocyclic ring-containing compound is 10.0 MPa^{1/2} or less.

### CROSS-REFERENCE TO RELATED APPLICATIONS

This application is a Continuation of PCT International Application No. PCT/JP2023/008850 filed on Mar. 8, 2023, which claims priority under 35 U.S.C. § 119(a) to Japanese Patent Application No. 2022-059236 filed on Mar. 31, 2022. The above applications are hereby expressly incorporated by reference, in their entirety, into the present application.

### BACKGROUND OF THE INVENTION

### 1. Field of the Invention

The present invention relates to a composition, a magnetic material, and an electronic component.

### 2. Description of the Related Art

With performance enhancement and miniaturization of electronic devices, a degree of integration of electronic circuits is increasing. As one of materials for improving the degree of integration, there is a coating-type (for example, a paste-like) composition containing magnetic particles. Since a magnetic material can be mounted in any shape by using such a composition, the miniaturization and the performance enhancement of the electronic devices are easily achieved as compared with a method in the related art, in which an individual piece of the magnetic material is disposed on a chip.

For example, JP2021-187894A discloses a resin composition containing a magnetic powder and a thermosetting resin, in which the magnetic powder includes a ferrite powder having an average particle diameter of 0.8 μm or less and a magnetic powder having an average particle diameter of 1.5 μm or more at a predetermined volume ratio. In addition, it is disclosed that alloy particles are used as the magnetic powder having an average particle diameter of 1.5 m or more.

### SUMMARY OF THE INVENTION

Meanwhile, a pressure cooker test (PCT test) has been known as an environmental test for evaluating moisture resistance of an electronic device. The PCT test is an accelerated life test of moisture resistance of the electronic device, which is performed by exposing the electronic device to an environment of a high temperature, a high pressure, and a high humidity.

In recent years, as basic performance of an electronic device using magnetic particles, excellent moisture resistance is further required in addition to high magnetic permeability, and in order to ensure reliability of the moisture resistance, the electronic device is often subjected to the PCT test.

The present inventor has prepared and examined the resin composition containing a magnetic powder with reference to JP2021-187894A, and has found that, in a case where a magnetic material formed from the resin composition is subjected to the PCT test, the magnetic particles (particularly, the alloy particles) in the magnetic material may rust, thereby significantly deteriorating magnetic properties. That is, it is clarified that there is room for further improving the moisture resistance of the magnetic material formed of the resin composition containing the magnetic powder.

An object of the present invention is to provide a composition with which a magnetic material having excellent magnetic permeability and moisture resistance can be formed.

Another object of the present invention is to provide a magnetic material and an electronic component.

As a result of conducting an extensive investigation to achieve the objects, the present inventor has found that the objects can be achieved by the following constitution.
[1] A composition comprising:
   magnetic particles;
   a heterocyclic ring-containing compound;
   a compound selected from the group consisting of an epoxy compound and an oxetane compound; and
   a dispersant,
   in which a polarity element of a Hansen solubility parameter of the heterocyclic ring-containing compound is 8.0 MPa^{1/2} or more, and
   a hydrogen bond element of the Hansen solubility parameter of the heterocyclic ring-containing compound is 10.0 MPa^{1/2} or less.
[2] The composition according to [1],
in which the dispersant includes a basic dispersant.
[3] The composition according to [1] or [2],
in which the magnetic particles include alloy particles.
[4] The composition according to any one of [1] to [3],
in which the magnetic particles include soft magnetic particles.
[5] The composition according to any one of [1] to [4],
in which the magnetic particles are spherical.
[6] The composition according to any one of [1] to [5],
in which a content of magnetic particles having a particle diameter of 10 μm or less is 10% by volume or more with respect to a total volume of the magnetic particles.
[7] The composition according to any one of [1] to [6],
in which the heterocyclic ring-containing compound is a nitrogen-containing ring compound.
[8] A magnetic material formed of the composition according to any one of [1] to [7].
[9] An electronic component comprising:
the magnetic material according to [8].
[10] The electronic component according to [9],
in which the electronic component is used as an inductor.
[11] The electronic component according to [9],
in which the electronic component is used as an antenna.

According to the present invention, it is to provide a composition with which a magnetic material having excellent magnetic permeability and moisture resistance can be formed.

In addition, according to the present invention, it is also possible to provide a magnetic material and an electronic component.

### DESCRIPTION OF THE PREFERRED EMBODIMENTS

Hereinafter, the present invention will be described in detail.

Description of configuration requirements described below may be made on the basis of representative embodiments of the present invention in some cases, but the present invention is not limited to such embodiments.

In notations for a group (atomic group) in the present specification, in a case where the group is cited without specifying that it is substituted or unsubstituted, the group includes both a group having no substituent and a group having a substituent as long as it does not impair the spirit of the present invention. For example, an “alkyl group” includes not only an alkyl group having no substituent (unsubstituted alkyl group), but also an alkyl group having a substituent (substituted alkyl group). In addition, “organic group” in the present specification refers to a group including at least 1 carbon atom.

“Actinic rays” or “radiation” in the present specification means, for example, a bright line spectrum of a mercury lamp, far ultraviolet rays typified by an excimer laser, extreme ultraviolet rays (EUV light), X-rays, electron beams (EB), or the like. “Light” in the present specification means actinic ray or radiation.

Unless otherwise specified, “exposure” in the present specification encompasses not only exposure by a bright line spectrum of a mercury lamp, far ultraviolet rays typified by an excimer laser, extreme ultraviolet rays, X-rays, EUV light, or the like, but also drawing by particle beams such as electron beams and ion beams.

In the present specification, a numerical range expressed using “to” is used in a meaning of a range that includes the preceding and succeeding numerical values of “to” as the lower limit value and the upper limit value, respectively.

In the present specification, (meth)acrylate represents acrylate or methacrylate, (meth)acryl represents acryl or methacryl, and (meth)acryloyl represents acryloyl or methacryloyl.

In the present specification, “solid content” of a composition means components forming a magnetic material. Therefore, in a case where the composition contains a solvent (such as an organic solvent and water), the “solid content” means all the components excluding the solvent. In a case where the components are components which form the magnetic material, the components are considered to be solid content even in a case where the components are liquid components.

In the present specification, “boiling point” means a standard boiling point, unless otherwise specified.

In addition, in the present specification, a weight-average molecular weight (Mw) is a value by a gel permeation chromatography (GPC) method in terms of polystyrene.

In the present specification, the GPC method is based on a method in which HLC-8020 GPC (manufactured by TOSOH CORPORATION) is used, TSKgel SuperHZM-H, TSKgel SuperHZ4000, and TSKgel SuperHZ2000 (manufactured by TOSOH CORPORATION, 4.6 mm ID×15 cm) are used as columns, and tetrahydrofuran (THF) is used as an eluent.

In addition, in the present specification, for each component, unless otherwise specified, one kind of substance corresponding to each component may be used alone, or two or more kinds thereof may be used in combination. Here, in a case where two or more kinds of substances corresponding to respective components are used in combination, the content of the components indicates the total content of the substances used in combination unless otherwise specified.

### [Composition]

The composition according to the embodiment of the present invention contains magnetic particles, a heterocyclic ring-containing compound (hereinafter, also referred to as “specific heterocyclic ring-containing compound”), a compound selected from the group consisting of an epoxy compound and an oxetane compound (hereinafter, also referred to as “specific binder component”), and a dispersant, in which a polarity element of a Hansen solubility parameter of the heterocyclic ring-containing compound is 8.0 MPa^{1/2} or more, and a hydrogen bond element of the Hansen solubility parameter of the heterocyclic ring-containing compound is 10.0 MPa^{1/2} or less.

With the above-described configuration, the composition according to the embodiment of the present invention can form a magnetic material having excellent magnetic permeability and moisture resistance.

Although the details thereof are not clear, the present inventor has presumed as follows.

The composition contains the specific heterocyclic ring-containing compound. The specific heterocyclic ring-containing compound can function as a rust inhibitor by adsorbing the magnetic particles on a heteroatom present in the molecule as an adsorption point. As a result of the study, the present inventor has found that, in a case where the polarity element of the Hansen solubility parameter of the specific heterocyclic ring-containing compound is 8.0 MPa^{1/2} or more, the moisture resistance of the magnetic material formed from the composition is excellent. In addition, the magnetic material formed from the composition which contains the magnetic particles modified with the dispersant on the surface of the particles tends to have high magnetic permeability by the magnetic particles being relatively uniformly present in the magnetic material. As a result of the study, the present inventor has found that, in a case where the hydrogen bond element of the Hansen solubility parameter of the specific heterocyclic ring-containing compound is 10.0 MPa^{1/2} or less, it is presumed that the specific heterocyclic ring-containing compound is capable of adsorbing to the magnetic particles without inhibiting the modifying effect of the dispersant on the magnetic particles (in other words, without decreasing the magnetic permeability of the magnetic material formed from the composition). That is, the magnetic material formed of the composition can exhibit both high magnetic permeability and excellent moisture resistance due to the above-described physical properties of the specific heterocyclic ring-containing compound. In a case where the hydrogen bond element of the Hansen solubility parameter is 10.0 MPa^{1/2} or less, it is presumed that affinity of the specific heterocyclic ring-containing compound with the specific binder component is relatively low, an adhesion force to the magnetic particles is stronger than a cohesive force with the components. It is considered that this also contributes to the achievement of both high magnetic permeability and excellent moisture resistance.

Hereinafter, the fact that the magnetic material formed of the composition according to the embodiment of the present invention has higher magnetic permeability and/or has more excellent moisture resistance may be referred to as “effect of the present invention is more excellent”.

Hereinafter, each component which can be contained in the composition will be described.

### [Magnetic Particles]

The composition contains magnetic particles.

The magnetic particles usually contain a metal atom.

In the present specification, examples of the above-described metal atom also include metalloid atoms such as boron, silicon, germanium, arsenic, antimony, and tellurium.

The magnetic particles may contain the above-described metal atom as an alloy including a metal element, a metal oxide, a metal nitride, or a metal carbide.

The above-described metal atom is not particularly limited, but preferably includes at least one metal atom selected from the group consisting of Fe, Ni, and Co.

A content of the at least one metal atom selected from the group consisting of Fe, Ni, and Co (in the case where a plurality of metal atoms are contained, the total content thereof) is preferably 50% by mass or more, more preferably 60% by mass or more, and still more preferably 70% by mass or more with respect to the total mass of metal atoms in the magnetic particles. The upper limit value of the above-described content is not particularly limited, but for example, it is 100% by mass or less, preferably 98% by mass or less and more preferably 95% by mass or less.

The magnetic particles may contain a material other than Fe, Ni, and Co, and specific examples thereof include Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Sr, Zr, Mn, Cr, Nb, Pb, Ca, B, C, N, and O.

In a case where the magnetic particles contain a metal atom other than Fe, Ni, and Co, it is preferable that the magnetic particles further contain one or more selected from the group consisting of Si, Cr, B, and Mo.

A shape of the magnetic particles is not particularly limited and may be any of a plate shape, an elliptical shape, a spherical shape, or an amorphous shape, but from the viewpoint that the effect of the present invention is more excellent, a spherical shape is preferable.

As the magnetic particles, alloy particles are preferable.

From the viewpoint that the effect of the present invention is more excellent, the alloy particles preferably contain Fe.

Examples of the metal atom other than Fe in the alloy particles include Ni and Co.

In a case where the alloy particles contain Fe, a content of Fe is preferably 50% by mass or more, more preferably 60% by mass or more, and still more preferably 70% by mass or more with respect to the content of metal atoms in the alloy particles. The upper limit value of the above-described content is not particularly limited, but for example, it is 100% by mass or less, preferably 98% by mass or less and more preferably 95% by mass or less.

A volume-average particle diameter of the alloy particles is not particularly limited and usually 1 to 60 μm, and from the viewpoint that the effect of the present invention is more excellent, it is preferably 1 to 30 μm and more preferably 1 to 20 μm.

The volume-average particle diameter of the alloy particles is a so-called median diameter (D50), and can be obtained based on a particle size distribution curve representing a volume-based frequency distribution of the alloy particles, which is obtained by a laser diffraction scattering-type particle size distribution analyzer (for example, product “LA960N” manufactured by HORIBA, Ltd).

Examples of the alloy particles include Fe—Co-based alloy particles (preferably, Permendur), Fe—Ni-based alloy particles (for example, Permalloy), Fe—Zr-based alloy particles, Fe—Mn-based alloy particles, Fe—Si-based alloy particles, Fe—Al-based alloy particles, Ni—Mo-based alloy particles (preferably, Supermalloy), Fe—Ni—Co-based alloy particles, Fe—Si—Cr-based alloy particles, Fe—Si—B-based alloy particles, Fe—Si—Al-based alloy particles (preferably, Sendust), Fe—Si—B—C-based alloy particles, Fe—Si—B—Cr-based alloy particles, Fe—Si—B—Cr—C-based alloy particles, Fe—Co—Si—B-based alloy particles, Fe—Si—B—Nb-based alloy particles, Fe nanocrystalline alloy particles, Fe-based amorphous alloy particles, and Co-based amorphous alloy particles. The above-described alloy may be amorphous.

As the magnetic particles, ferrite particles are also preferable.

In addition to Fe constituting the iron oxide, the ferrite particles preferably contain at least one metal atom selected from the group consisting of Ni, Mn, and Co, and from the viewpoint that the effect of the present invention is more excellent, it is more preferable that the ferrite particles contain an Ni atom.

In addition, the ferrite particles may contain a material other than Ni, Mn, FE, and Co, and specific examples thereof include Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Sr, Zr, Cr, Nb, Pb, Ca, B, C, N, and O.

A volume-average particle diameter of the ferrite particles is not particularly limited and usually 1 to 60 μm, and from the viewpoint that the effect of the present invention is more excellent, it is preferably 5 to 55 μm, more preferably 10 to 50 μm, and still more preferably 20 to 50 μm.

The volume-average particle diameter of the ferrite particles is a so-called median diameter (D50), and can be obtained based on a particle size distribution curve representing a volume-based frequency distribution of the ferrite particles, which is obtained by a laser diffraction scattering-type particle size distribution analyzer (for example, product “LA960N” manufactured by HORIBA, Ltd).

Examples of the ferrite particles include Ni ferrite, Mn ferrite, and spinel ferrite (preferably, Ni—Zn-based ferrite, Mn—Zn-based ferrite, or Fe—Mn-based ferrite).

Among these, it is preferable that the magnetic particles include soft magnetic particles from the viewpoint of further reducing the loss. Examples of the soft magnetic particles include Fe-based amorphous alloy particles, Fe—Si—Cr-based alloy particles, Fe nanocrystalline alloy particles, Fe—Ni—Co-based alloy particles, Co-based amorphous alloy particles, Ni—Mo-based alloy particles, Ni ferrite particles, and Mn ferrite particles.

A surface layer may be provided on at least a part of a surface of the magnetic particles. Since the magnetic particles have the surface layer, a function according to a material of the surface layer can be imparted to the magnetic particles.

Examples of the surface layer include an inorganic layer and an organic layer, and an organic layer is preferable.

From the viewpoint that it is possible to form a surface layer excellent in at least one of insulation properties, gas barrier properties, or chemical stability, a compound for forming the inorganic layer is preferably a metal oxide, a metal nitride, a metal carbide, a metal phosphate compound, a metal borate compound, or a silicate compound (for example, a silicate ester such as tetraethyl orthosilicate or a silicate such as sodium silicate). Specific examples of elements contained in these compounds include Fe, Al, Ca, Mn, Zn, Mg, V, Cr, Y, Ba, Sr, Ge, Zr, Ti, Si, and rare earth elements.

Examples of a material constituting the inorganic layer obtained from the compound for forming an inorganic layer include silicon oxide, germanium oxide, titanium oxide, aluminum oxide, zirconium oxide, and magnesium oxide, and the inorganic layer may be a layer containing two or more kinds thereof.

Examples of a compound for forming the organic layer include an acrylic monomer. Specific examples of the acrylic monomer include compounds described in paragraphs 0022 to 0023 of JP2019-067960A.

Examples of a material constituting the organic layer obtained from the compound for forming an organic layer include an acrylic resin.

A thickness of the surface layer is not particularly limited, but from the viewpoint that the function of the surface layer is further exhibited, it is preferably 3 to 1,000 nm.

The magnetic particles may be used alone or in combination of two or more kinds thereof.

In a case where two or more kinds of magnetic particles are used in combination, a combination of the ferrite particles and the alloy particles or a combination of the alloy particles and the alloy particles is preferable, and a combination of the ferrite particles and the alloy particles is more preferable.

In addition, in a case where the ferrite particles and the alloy particles are used in combination as the magnetic particles, a content ratio (mass ratio; ferrite particles/alloy particles) is preferably 30/70 to 70/30 and more preferably 40/60 to 60/40.

In addition, in a case where the alloy particles (first alloy particles) and the alloy particles (second alloy particles) are used in combination as the magnetic particles, a content ratio (mass ratio; first alloy particles/second alloy particles) is preferably 30/70 to 70/30, and more preferably 40/60 to 60/40.

A content of the magnetic particles (in a case where a plurality of types of magnetic particles are contained, the total content thereof) in the composition is preferably 70% by mass or more, more preferably 75% by mass or more, still more preferably 80% by mass or more, and particularly preferably 90% by mass or more with respect to the total mass of the composition. In addition, the upper limit value thereof is preferably 95% by mass or less, and more preferably 90% by mass or less.

The content of the magnetic particles (in a case where a plurality of types of magnetic particles are contained, the total content thereof) in the composition is preferably 70% by mass or more, more preferably 75% by mass or more, still more preferably 80% by mass or more, particularly preferably 90% by mass or more, and most preferably 92% by mass or more with respect to the total solid content of the composition. In addition, the upper limit value thereof is preferably 97% by mass or less, and more preferably 95% by mass or less.

In addition, in the composition, a content of magnetic particles having a particle diameter of 10 μm or less is preferably 10% by volume or more, more preferably 20% by volume or more, and still more preferably 30% by volume or more with respect to the total volume of the magnetic particles. In the magnetic material formed from the composition, as a surface area of the magnetic particles contained in the magnetic material is larger (that is, the particle diameter of the magnetic particles contained in the magnetic material is smaller), there is a tendency that the deterioration of moisture resistance due to rusting of the magnetic particles is likely to occur. In the magnetic material formed from the composition according to the embodiment of the present invention, even in a case where a large amount of magnetic particles having a small particle diameter of 10 μm or less are contained, the deterioration in moisture resistance due to rusting of the magnetic particles is unlikely to occur. The upper limit value of the content of the magnetic particles having a particle diameter of 10 μm or less in the composition is not particularly limited, but from the viewpoint that the effect of the present invention is more excellent, it is preferably 85% by volume or less, more preferably 70% by volume or less, and still more preferably 60% by volume or less with respect to the total mass of the magnetic particles.

The content of the magnetic particles having a particle diameter of 10 μm or less is determined by the following procedure.

First, using a scanning electron microscope (SEM; for example, “S-4800H” manufactured by Hitachi High-Tech Corporation or the like can be used), the magnetic particles are observed, and 1,000 magnetic particles are randomly selected and imaged in any observation field of view.

Next, the obtained image information is introduced into an image analysis apparatus (for example, image analysis software “Image-Pro PLUS” manufactured by Media Cybernetics, Inc.) through an interface to perform the analysis, thereby obtaining a projection area of each particle. The projection area is intended to be a projection area of primary particles.

In addition, for each particle, an equivalent circle diameter is calculated from the projection area of the magnetic particles obtained by the above-described procedure. The equivalent circle diameter is a diameter of a true circle in a case where a true circle having the same projection area as the projection area of the magnetic particles during the observation is assumed. Next, a volume of each of the 1,000 magnetic particles which are the above-described measurement target is calculated by the following expression (1).

Volume=(Equivalent circle diameter of magnetic particles)³×(π/6) Expression (1):

Next, from the above-described measurement results, “total volume of magnetic particles having a particle diameter (equivalent circle diameter) of 10 μm or less” and “total volume of 1,000 magnetic particles” are obtained, and a volume fraction (%) of the “total volume of magnetic particles having a particle diameter (equivalent circle diameter) of 10 μm or less” with respect to the “total volume of 1,000 magnetic particles” is calculated.

The above-described measurements may be performed by obtaining powder of the magnetic particles from the composition containing the magnetic particles and an organic solvent by an arbitrary method (baking, sedimentation, or the like), or may be performed on a film formed of the composition containing the magnetic particles and an organic solvent. In particular, the above-described measurements are performed on the film formed of the composition. The above-described film may be a coating film or a cured film.

### [Specific Heterocyclic Ring-Containing Compound]

The composition contains the specific heterocyclic ring-containing compound.

The specific heterocyclic ring-containing compound is a compound including one or more heterocyclic rings.

In addition, the specific heterocyclic ring-containing compound is a component different from an epoxy compound and an oxetane compound, which will be described later, and a dispersant.

As a heteroatom included in the heterocyclic ring, one or more selected from the group consisting of a nitrogen atom, a sulfur atom, and an oxygen atom are preferable, one or more selected from the group consisting of a nitrogen atom and a sulfur atom are more preferable, and a nitrogen atom is still more preferable. In other words, as the specific heterocyclic ring-containing compound, a nitrogen-containing ring compound is preferable.

In the specific heterocyclic ring-containing compound, among three vectors of Hansen solubility parameters (HSP) (dispersion element of Hansen solubility parameter vector: δD, polarity element of Hansen solubility parameter vector: δP (HSP-p), and hydrogen bond element of Hansen solubility parameter vector: δH) (HSP-h), it is satisfied that the polarity element (δP) is 8.0 MPa^{1/2} or more and the hydrogen bonding element (δH) is 10.0 MPa^{1/2} or less.

In the present specification, each value of the polarity element (δP) and the hydrogen bond element (δH) of the Hansen solubility parameters is a value calculated by software Hansen Solubility Parameter in Practice (HSPiP) ver. 4.1.07. Here, in a case where the calculation is not possible due to the software, values calculated based on Table 2 in paper “Hansen solubility parameters 50th anniversary conference, preprint PP. 1 to 13, (2017), Hiroshi Yamamoto, Steven Abbott, Charles M. Hansen” published in yamamoto preprint Part 1 of a homepage “https://pirika.com/index-j.html” (https://pirika.com/HSP/HSP-J/HSP50/Preprint-Part10%20Yamamoto.pdf) can be used.

From the viewpoint that the effect of the present invention is more excellent, in the specific heterocyclic ring-containing compound, the polarity element (δP) of the Hansen solubility parameter is preferably 8.5 MPa^{1/2} or more, more preferably 9.0 MPa^{1/2} or more, still more preferably 10.0 MPa^{1/2} or more, and particularly preferably 11.0 MPa^{1/2} or more. The upper limit value thereof is not particularly limited, and is, for example, preferably 20.0 MPa^{1/2} or less. In addition, from the viewpoint that the effect of the present invention is more excellent, the hydrogen bond element (δH) of the Hansen solubility parameter is preferably 9.0 MPa^{1/2} or less and more preferably 8.5 MPa^{1/2} or less. The lower limit value thereof is not particularly limited, and is, for example, preferably 1.0 MPa^{1/2} or more.

Among these, as the specific heterocyclic ring-containing compound, an azole-based compound is preferable. The azole-based compound is intended to be a compound including a 5-membered heterocyclic ring which contains one or more nitrogen atoms, and the number of nitrogen atoms is preferably 1 to 4.

In addition, the azole-based compound may have an atom other than a nitrogen atom, as a heteroatom.

In addition, the azole-based compound may have a substituent on the above-described 5-membered heterocyclic ring.

In addition, the azole-based compound may have a polycyclic structure in which an aromatic hydrocarbon ring and/or an aromatic heterocyclic ring are further fused to the above-described 5-membered heterocyclic ring. In a case where the azole-based compound has such a polycyclic structure, the aromatic hydrocarbon ring and/or the aromatic heterocyclic ring fused to the 5-membered heterocyclic ring may have a substituent.

Examples of the azole-based compound include a compound having a pyrrole skeleton, an imidazole skeleton, a pyrazole skeleton, an isothiazole skeleton, an isoxazole skeleton, a triazole skeleton, a tetrazole skeleton, a thiazole skeleton, an oxazole skeleton, a thiadiazole skeleton, or an oxadiazole skeleton.

The azole-based compound may be an azole-based compound having a polycyclic structure in which an aromatic hydrocarbon ring or an aromatic heterocyclic ring is further fused to the above-described skeleton. Examples of the above-described azole-based compound having a polycyclic structure include a compound having a benzimidazole skeleton, a benzotriazole skeleton, a benzothiadiazole skeleton, a benzothiazole skeleton, a carbazole skeleton, an indole skeleton, a purine skeleton, an indazole skeleton, a benzoxazole skeleton, or a naphthimidazole skeleton.

The substituent which can be included in the azole-based compound is not particularly limited, and examples thereof include a halogen atom (a fluorine atom, a chlorine atom, a bromine atom, an iodine atom, and the like), an alkyl group (which may be linear, branched, or cyclic), an alkenyl group, an alkynyl group, an aryl group, a heterocyclic group, an acyl group, an alkoxycarbonyl group, an aryloxycarbonyl group, a heterocyclic oxycarbonyl group, a carbamoyl group, a carbazoyl group, a carboxy group or a salt thereof, an oxalyl group, an oxamoyl group, a cyano group, a carbonimidoyl group, a formyl group, a hydroxy group, an alkoxy group, an aryloxy group, a heterocyclic oxy group, an acyloxy group, a carbonyloxy group, a carbamoyloxy group, a sulfonyloxy group, an amino group, an acylamino group, a sulfonamide group, a ureido group, a thioureido group, an N-hydroxyureido group, an imido group, a carbonylamino group, a sulfamoylamino group, a semicarbazide group, a thiosemicarbazide group, a hydrazino group, an ammonio group, an oxamoylamino group, an N-(alkyl or aryl)sulfonylureido group, an N-acylureido group, an N-acylsulfamoylamino group, a hydroxyamino group, a nitro group, a heterocyclic group including a quaternized nitrogen atom (for example, a pyridinio group, an imidazolio group, a quinolinio group, an isoquinolinio group, and the like), an isocyano group, an imino group, a mercapto group, an (alkyl, aryl, or heterocyclic)thio group, an (alkyl, aryl, or heterocyclic)dithio group, an (alkyl or aryl)sulfonyl group, an (alkyl or aryl)sulfinyl group, a sulfo group or a salt thereof, a sulfamoyl group (as a sulfamoyl group having a substituent, for example, an N-acylsulfamoyl group and an N-sulfonylsulfamoyl group) or a salt thereof, a phosphino group, a phosphinyl group, a phosphinyloxy group, a phosphinylamino group, and a silyl group.

Examples of the “salt” described above include cations such as an alkali metal, an alkaline earth metal, and a heavy metal; and organic cations such as an ammonium ion and a phosphonium ion.

Among these, as the specific heterocyclic ring-containing compound, a compound having a benzimidazole skeleton, a compound having a benzotriazole skeleton, or a compound having a benzothiadiazole is preferable.

A molecular weight of the specific heterocyclic ring-containing compound is, for example, preferably 50 to 10,000, more preferably 80 to 1,000, and still more preferably 100 to 500.

Specific examples of the specific heterocyclic ring-containing compound include 2-mercaptobenzimidazole (δP: 8.5 MPa^{1/2} and δH: 8.3 MPa^{1/2}), 1H-benzotriazole (δP: 12.4 MPa^{1/2} and δH: 9.0 MPa^{1/2}) and 2,1,3-benzothiadiazole (δP: 9.1 MPa^{1/2} and δH: 7.1 MPa^{1/2}).

The specific heterocyclic ring-containing compound may be used alone or in combination of two or more kinds thereof.

A content of the specific heterocyclic ring-containing compound (in a case where a plurality of types of specific heterocyclic ring-containing compounds are contained, the total content thereof) in the composition is preferably 0.01% by mass or more, more preferably 0.05% by mass or more, and still more preferably 0.1% by mass or more with respect to the total mass of the composition. In addition, the upper limit value thereof is preferably 5.0% by mass or less, more preferably 3.0% by mass or less, and still more preferably 2.0% by mass or less.

The content of the specific heterocyclic ring-containing compound (in a case where a plurality of types of specific heterocyclic ring-containing compounds are contained, the total content thereof) in the composition is preferably 0.01% by mass or more, more preferably 0.05% by mass or more, and still more preferably 0.1% by mass or more with respect to the total solid content of the composition. In addition, the upper limit value thereof is preferably 5.0% by mass or less, more preferably 3.0% by mass or less, and still more preferably 2.0% by mass or less.

### [Specific Binder Component]

The composition contains one or more compounds (specific binder components) selected from the group consisting of an epoxy compound and an oxetane compound.

The epoxy compound is intended to be a compound including at least one epoxy group. In addition, the oxetane compound is intended to be a compound including at least one oxetanyl group.

In addition, in the epoxy compound, the epoxy group may be fused to a cyclic group (an alicyclic group or the like). The number of carbon atoms in the cyclic group which is fused with the epoxy group is preferably 5 to 15. In addition, in the above-described cyclic group, a portion other than the portion which is fused with the epoxy group may be monocyclic or polycyclic. In one cyclic group, only one epoxy group may be fused, or two or more epoxy groups may be fused.

In addition, in the oxetane compound, the oxetanyl group may be fused to a cyclic group (an alicyclic group or the like). The number of carbon atoms in the cyclic group which is fused with the oxetanyl group is preferably 5 to 15. In addition, in the above-described cyclic group, a portion other than the portion which is fused with the oxetanyl group may be monocyclic or polycyclic. In one cyclic group, only one oxetanyl group may be fused, or two or more oxetanyl groups may be fused.

The epoxy compound and the oxetane compound may be any of a monomer, an oligomer, or a polymer.

As the epoxy compound, a compound including 2 to 10 epoxy groups is preferable.

As the oxetane compound, a compound including 2 to 10 oxetanyl groups is preferable.

A molecular weight (or a weight-average molecular weight) of the epoxy compound and the oxetane compound is not particularly limited, but is, for example, preferably 2,000 or less.

The specific binder component may be used alone or as a mixture of two or more kinds thereof.

A content of the specific binder component (in a case where a plurality of types of specific binder components are contained, the total content thereof) is preferably 1.0% to 24% by mass, more preferably 1.0% to 15% by mass, still more preferably 1.0% to 12% by mass, particularly preferably 1.0% to 10% by mass, and most preferably 1.0% to 7% by mass with respect to the total mass of the composition.

The content of the specific binder component (in a case where a plurality of types of specific binder components are contained, the total content thereof) is preferably 1.0% to 24% by mass, more preferably 1.0% to 15% by mass, still more preferably 1.0% to 12% by mass, particularly preferably 1.0% to 10% by mass, and most preferably 1.0% to 7% by mass with respect to the total solid content of the composition.

From the viewpoint that the effect of the present invention is more excellent, a mass content ratio of the content of the specific heterocyclic ring-containing compound to the content of the dispersant (Content of specific heterocyclic ring-containing compound/Content of dispersant) is preferably 0.1 to 3.0, more preferably 0.1 to 2.0, and still more preferably 0.1 to 1.5.

As an aspect of the mass content ratio of the content of the specific heterocyclic ring-containing compound to the content of the dispersant (Content of specific heterocyclic ring-containing compound/Content of dispersant), it is also preferably 0.2 to 0.6.

Specific examples of the specific binder component will be described below.

Examples of the epoxy compound include an epoxy resin which is a glycidyl etherified product of a phenol compound (for example, a bisphenol A-type epoxy resin, a bisphenol F-type epoxy resin, and the like), an epoxy resin which is a glycidyl etherified product of various novolac resins (for example, a phenol novolac-type epoxy resin, a cresol novolac-type epoxy resin, and the like), an alicyclic epoxy resin, an aliphatic epoxy resin, a heterocyclic epoxy resin, a glycidyl ester-based epoxy resin, a glycidyl amine-based epoxy resin, an epoxy resin obtained by glycidylating halogenated phenols, a condensate of a silicon compound having an epoxy group and another silicon compound, and a copolymer of a polymerizable unsaturated compound having an epoxy group and another polymerizable unsaturated compound.

With regard to a commercially available product of the epoxy compound, for example, the description in paragraph 0191 and the like of JP2012-155288A can be referred to, the contents of which are incorporated herein by reference.

In addition, examples of the commercially available product of the epoxy compound also include Marproof G-0150M, G-0105SA, G-0130SP, G-0250SP, G-10055, G-1005SA, G-1010S, G-2050M, G-01100, and G-01758 (manufactured by NOF CORPORATION., epoxy group-containing polymer); ADEKA RESIN EP-40005, EP-40035, EP-40105, and EP-4011S (all of which are manufactured by ADEKA Corporation); NC-2000, NC-3000, NC-7300, XD-1000, EPPN-501, and EPPN-502 (all of which are manufactured by ADEKA Corporation) and jER1031S.

Specific examples of the bisphenol A-type epoxy resin and the bisphenol F-type epoxy resin include ZX1059 (manufactured by NIPPON STEEL Chemical & Material Co., Ltd.) and 828US (manufactured by Mitsubishi Chemical Corporation).

Examples of a commercially available product of the phenol novolac-type epoxy resin include JER-157S65, JER-152, JER-154, and JER-157S70 (all of which are manufactured by Mitsubishi Chemical Corporation).

Examples of the polymerizable monomer or oligomer having two or more epoxy groups in the molecule also include ZX1658GS (liquid 1,4-glycidyl cyclohexane-type epoxy resin, manufactured by NIPPON STEEL Chemical & Material Co., Ltd.), HP-4700 (naphthalene-type tetrafunctional epoxy resin, manufactured by DIC Corporation), NC3000L (biphenyl-type epoxy resin, manufactured by Nippon Kayaku Co., Ltd.), or the like.

As specific examples of a polymer having an oxetanyl group in the side chain and a polymerizable monomer or oligomer having two or more oxetanyl groups in the molecule, ARON OXETANE OXT-121, OXT-221, OX-SQ, and PNOX (all of which are manufactured by Toagosei Co., Ltd) can be used.

Examples of the epoxy compound also include unsaturated compounds having an alicyclic epoxy group, which is described in, for example, paragraph 0045 of JP2009-265518A.

Examples of the epoxy compound include a monofunctional or polyfunctional glycidyl ether compound. Examples of the monofunctional or polyfunctional glycidyl ether compound also include glycidyl ether compounds of a polyhydric alcohol having 3 or higher valance, such as (poly)alkylene glycol diglycidyl ether, glycerol, sorbitol, and (poly)glycerol.

Examples of the epoxy compound also include a compound including a caprolactone structure, represented by Formula (Z-1).

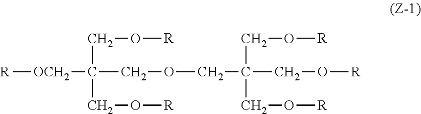

In Formula (Z-1), all six R's are groups represented by Formula (Z-2E), or one to five among the six R's are groups represented by Formula (Z-2E) and the others are groups represented by Formula (Z-3E).

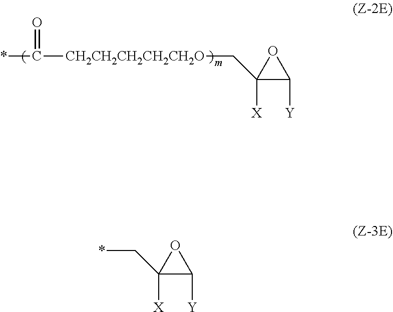

In Formula (Z-2E), m represents a number of 1 or 2, X and Y each independently represent a hydrogen atom or a substituent (preferably, an alkyl group preferably having 1 to 3 carbon atoms), and “*” represents a bonding site.

In Formula (Z-3E), X and Y each independently represent a hydrogen atom or a substituent (preferably, an alkyl group preferably having 1 to 3 carbon atoms), and represents a bonding site.

Examples of the epoxy compound also include a compound represented by Formula (Z-4) or (Z-5).

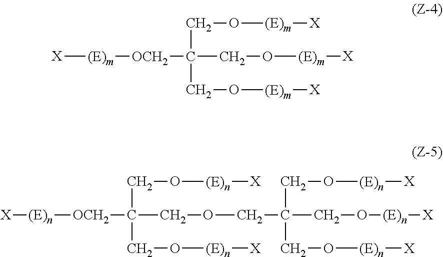

In Formulae (Z-4) and (Z-5), E represents —((CH₂)_{y}CH₂O)— or —((CH₂)_{y}CH(CH₃)O)—, y represents an integer of 0 to 10, and X represents the group represented by Formula (Z-3E) described above or a hydrogen atom.

In Formula (Z-4), the total number of groups represented by Formula (Z-3E) described above is 2 to 4, m represents an integer of 0 to 10, and the sum of m's is an integer of 0 to 40.

In Formula (Z-5), the total number of groups represented by Formula (Z-3E) described above is 2 to 6 (preferably 5 or 6), n represents an integer of 0 to 10, and the sum of n's is an integer of 0 to 60.

In Formula (Z-4), m is preferably an integer of 0 to 6 and more preferably an integer of 0 to 4.

In addition, the total number of m's is preferably an integer of 2 to 40, more preferably an integer of 2 to 16, and still more preferably an integer of 4 to 8.

In Formula (Z-5), n is preferably an integer of 0 to 6 and more preferably an integer of 0 to 4.

In addition, the total number of n's is preferably an integer of 3 to 60, more preferably an integer of 3 to 24, and still more preferably an integer of 6 to 12.

Furthermore, a form in which a terminal on the oxygen atom side of —((CH₂)_{y}CH₂O)— or ((CH₂)_{y}CH(CH₃)O)— in Formula (Z-4) or Formula (Z-5) is bonded to X is preferable.

Among the compounds represented by Formula (Z-4) or Formula (Z-5), a pentaerythritol derivative and/or a dipentaerythritol derivative is more preferable.

Examples of the epoxy compound also include a compound having a structure in which N pieces of cyclic groups fused with the epoxy group are bonded to each other through a linking group.

N is an integer of 2 or more, preferably an integer of 2 to 6 and more preferably 2. In the above-described linking group, the total number of atoms other than hydrogen atoms is preferably 1 to 20 and more preferably 2 to 6. In a case where N is 2, examples of the above-described linking group include an alkyleneoxycarbonyl group.

Examples of the oxetane compound also include a compound having a structure in which N pieces of cyclic groups fused with the oxetanyl group are bonded to each other through a linking group.

N is an integer of 2 or more, preferably an integer of 2 to 6 and more preferably 2. In the above-described linking group, the total number of atoms other than hydrogen atoms is preferably 1 to 20 and more preferably 2 to 6. In a case where N is 2, examples of the above-described linking group include an alkyleneoxycarbonyl group.

Examples of commercially available products of the epoxy compound and the oxetane compound include polyfunctional aliphatic glycidyl ether compounds such as DENACOL EX-212L, EX-214L, EX-216L, EX-321L, and EX-850L (all of which are Nagase ChemteX Corporation). These are low-chlorine products, but EX-212, EX-214, EX-216, EX-314, EX-321, EX-614, EX-850, and the like, which are not low-chlorine products, can also be used.

In addition, CELLOXIDE 2021P (manufactured by Daicel Corporation, polyfunctional epoxy monomer) and EHPE 3150 (manufactured by Daicel Corporation, polyfunctional epoxy/oxiranyl monomer) can also be used.

### [Other Binder Components]

The composition may contain a binder component other than the specific binder component.

Examples of other binder components include a polyvinyl acetal resin, a phenoxy resin, a (meth)acrylic resin, an ene-thiol resin, a polycarbonate resin, a polyether resin, a polyarylate resin, a polysulfone resin, a polyethersulfone resin, a polyphenylene resin, a polyarylene ether phosphine oxide resin, a polyimide resin, a polyamidoimide resin, a polyolefin resin, a cyclic olefin resin, a polyester resin, and a styrene resin.

Examples of a commercially available product of the polyvinyl acetal resin include “KS-1” manufactured by SEKISUI CHEMICAL CO., LTD.

Examples of a commercially available product of the phenoxy resin include “YX7553BH30” (manufactured by Mitsubishi Chemical Corporation).

Examples of the other binder components also include resins described in Examples of WO2016/088645A.

### [Dispersant]

The composition contains a dispersant.

The dispersant is a resin which improves dispersibility of the magnetic particles, and usually has a functional group capable of interacting with the magnetic particles (for example, an acid group, a basic group, a coordinating group, a reactive functional group, and the like).

Examples of the acid group include a carboxylic acid group, a sulfonic acid group, a phosphoric acid group, and a phenolic hydroxyl group. Examples of the basic group include an amino group (a group obtained by removing one hydrogen atom from ammonia, a primary amine, or a secondary amine), an imino group, a heterocyclic ring including an N atom, and an amide group. Examples of the coordinating group and the reactive functional group include an acetoxyacetoxy group, a trialkoxysilyl group, an isocyanate group, an acid anhydride, and an acid chloride.

As the dispersant, a resin having an acidic group (in other words, an acidic dispersant) or a resin having a basic group (in other words, a basic dispersant) is preferable, and a resin having a basic group (a basic dispersant) is more preferable.

In a case where the dispersant has an acid group, an acid value of the dispersant is, for example, preferably 10 to 500 mgKOH/g and more preferably 30 to 400 mgKOH/g.

It is also preferable that the dispersant includes a repeating unit having a graft chain. That is, it is also preferable that the dispersant is a resin having a repeating unit having a graft chain (hereinafter, also referred to as “resin A”).

As the graft chain in the repeating unit having a graft chain is longer, the effect of steric repulsion, which improves the dispersibility of the magnetic particles, is higher. On the other hand, in a case where the graft chain is too long, an attraction force to the magnetic particles decreases, and the dispersibility of the magnetic particles tends to decrease. Therefore, in the graft chain, the number of atoms excluding the hydrogen atoms is preferably 40 to 10,000, the number of atoms excluding the hydrogen atoms is more preferably 50 to 2,000, and the number of atoms excluding the hydrogen atoms is still more preferably 60 to 500.

Here, the graft chain refers to a portion from the base (in a group which is branched off from the main chain, an atom bonded to the main chain) of a main chain to the terminal of a group branched off from the main chain.

In addition, the graft chain preferably includes a polymer structure, and examples of such a polymer structure include a poly(meth)acrylate structure (for example, a poly(meth)acrylic structure), a polyester structure, a polyurethane structure, a polyurea structure, a polyamide structure, and a polyether structure.

In order to improve interaction between the graft chain and the solvent, thereby improving the dispersibility of the magnetic particles, the graft chain is preferably a graft chain including at least one selected from the group consisting of a polyester structure, a polyether structure, and a poly(meth)acrylate structure, and more preferably a graft chain including at least one of a polyester structure or a polyether structure.

The resin A may be a resin obtained using a macromonomer having a graft chain (monomer which has a polymer structure and constitutes a graft chain by being bonded to the main chain of).

The macromonomer having a graft chain (monomer which has a polymer structure and constitutes a graft chain by being bonded to the main chain of) is not particularly limited, but a macromonomer including a reactive double bond group can be suitably used.

As commercially available macromonomers which correspond to the above-described repeating unit having a graft chain and are suitably used for the synthesis of the resin A, AA-6, AA-10, AB-6, AS-6, AN-6, AW-6, AA-714, AY-707, AY-714, AK-5, AK-30, and AK-32 (all are trade names, manufactured by TOAGOSEI CO., LTD.), and BLEMMER PP-100, BLEMMER PP-500, BLEMMER PP-800, BLEMMER PP-1000, BLEMMER 55-PET-800, BLEMMER PME-4000, BLEMMER PSE-400, BLEMMER PSE-1300, and BLEMMER 43PAPE-600B (all are trade names, manufactured by NOF CORPORATION.) are used. Among these, AA-6, AA-10, AB-6, AS-6, AN-6, or BLEMMER PME-4000 is preferable.

The resin A preferably includes at least one structure selected from the group consisting of poly(methyl acrylate), poly(methyl methacrylate), and a cyclic or chain-like polyester; more preferably has at least one structure selected from the group consisting of poly(methyl acrylate), poly(methyl methacrylate), and a chain-like polyester; and still more preferably has at least one structure selected from the group consisting of a poly(methyl acrylate) structure, a poly(methyl methacrylate) structure, a polycaprolactone structure, and a polyvalerolactone structure. The resin A may include the above-described structure alone, or may include a plurality of the above-described structures.

Here, the polycaprolactone structure refers to a structure including a structure, which is obtained by ring opening of ε-caprolactone, as a repeating unit. The polyvalerolactone structure refers to a structure including a structure, which is obtained by ring opening of 6-valerolactone, as a repeating unit.

In a case where the resin A includes repeating units represented by Formula (1) and Formula (2), which will be described later, in which each of j and k is 5, the above-described polycaprolactone structure can be introduced into the resin A.

In addition, in a case where the resin A includes repeating units represented by Formula (1) and Formula (2), which will be described later, in which each of j and k is 4, the above-described polyvalerolactone structure can be introduced into the resin.

In addition, in a case where the resin A includes a repeating unit represented by Formula (4), which will be described later, in which X⁵ is a hydrogen atom and R⁴ is a methyl group, the above-described poly(methyl acrylate) can be introduced into the resin A.

In addition, in a case where the resin A includes a repeating unit represented by Formula (4), which will be described later, in which X⁵ is a methyl group and R⁴ is a methyl group, the above-described poly(methyl methacrylate) can be introduced into the resin A.

In a case where the resin A includes a repeating unit represented by Formula (5), which will be described later, in which j in Formula (5) is 5, the above-described polycaprolactone structure can be introduced into the resin A.

In addition, in a case where the resin A includes a repeating unit represented by Formula (5), which will be described later, in which j in Formula (5) is 4, the above-described polyvalerolactone structure can be introduced into the resin.

In a case where the composition contains the resin A, a content of the resin A is preferably 1% to 24% by mass, preferably 0.001% to 20.0% by mass, more preferably 0.01% to 15.0% by mass, still more preferably 0.05% to 10.0% by mass, and particularly preferably 0.05% to 5.0% by mass with respect to the total mass of the composition.

The content of the resin A is preferably 0.001% to 20.0% by mass, more preferably 0.01% to 15.0% by mass, still more preferably 0.05% to 10.0% by mass, and particularly preferably 0.05% to 5.0% by mass with respect to the total solid content of the composition.

### (Resin A1)

Examples of one suitable aspect of the resin A include a resin including a repeating unit including a polyalkyleneimine structure and a polyester structure (hereinafter, “resin A1”). It is preferable that the repeating unit including a polyalkyleneimine structure and a polyester structure includes the polyalkyleneimine structure in a main chain and includes the polyester structure as a graft chain.

The above-described polyalkyleneimine structure is a polymerization structure including two or more identical or different alkyleneimine chains. Specific examples of the alkyleneimine chain include alkyleneimine chains represented by Formulae (4A) and (4B).

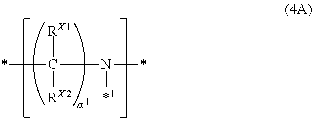

In Formula (4A), R^{X1} and R^{X2} each independently represent a hydrogen atom or an alkyl group. a¹ represents an integer of 2 or more. *¹ represents a bonding position with a polyester chain, an adjacent alkyleneimine chain, or with a hydrogen atom or a substituent. * in Formula (4A) and Formula (4B) and *² in Formula (4B) each independently represent a position where an adjacent alkyleneimine chain, or a hydrogen atom or a substituent is bonded.

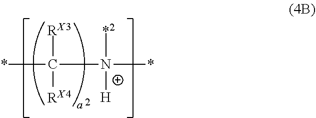

In Formula (4B), R^{X3} and R^{X4} each independently represent a hydrogen atom or an alkyl group. a² represents an integer of 2 or more. The alkyleneimine chain represented by Formula (4B) is bonded to a polyester chain having an anionic group by forming a salt-crosslinked group from N⁺ specified in Formula (4B) and the anionic group included in the polyester chain.

Among these, * in Formula (4A) and Formula (4B) preferably represents a position where an adjacent alkyleneimine chain is bonded.

R^{X1} and R^{X2} in Formula (4A) and R^{X3} and R^{X4} in Formula (4B) each independently represent a hydrogen atom or an alkyl group.

The number of carbon atoms in the alkyl group is preferably 1 to 6 and more preferably 1 to 3.

In Formula (4A), both R^{X1} and R^{X2} are preferably a hydrogen atom.

In Formula (4B), both R^{X3} and R^{X4} are preferably a hydrogen atom.

a¹ in Formula (4A) and a² in Formula (4B) are not particularly limited as long as they are an integer of 2 or more. The upper limit value thereof is preferably 10 or less, more preferably 6 or less, still more preferably 4 or less, even more preferably 2 or 3, and particularly preferably 2.

In Formula (4A) and Formula (4B), * represents a bonding position with an adjacent alkyleneimine chain or with a hydrogen atom or a substituent.

Examples of the above-described substituent include a substituent such as an alkyl group (for example, an alkyl group having 1 to 6 carbon atoms). In addition, a polyester chain may be bonded as the substituent.

The alkyleneimine chain represented by Formula (4A) is preferably linked to the polyester chain at the position of *¹ described above. Specifically, it is preferable that a carbonyl carbon in the polyester chain is bonded at the position of *¹ described above.

Examples of the above-described polyester chain include a polyester chain represented by Formula (5A).

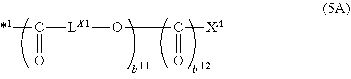

In a case where the alkyleneimine chain is the alkyleneimine chain represented by Formula (4B), it is preferable that the polyester chain includes an anionic group (preferably, oxygen anion O⁻), and this anionic group and N⁺ in Formula (4B) form a salt-crosslinked group.

Examples of such a polyester chain include a polyester chain represented by Formula (5B).

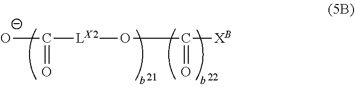

L^{X1} in Formula (5A) and L^{X2} in Formula (5B) each independently represent a divalent linking group. Preferred examples of the divalent linking group include an alkylene group having 3 to 30 carbon atoms.

b¹¹ in Formula (5A) and b²¹ in Formula (5B) each independently represent an integer of 2 or more, preferably an integer of 6 or more, and the upper limit thereof is, for example, 200 or less.

b¹² in Formula (5A) and b²² in Formula (5B) each independently represent 0 or 1.

X^{A} in Formula (5A) and X^{B} in Formula (5B) each independently represent a hydrogen atom or a substituent. Examples of the substituent include an alkyl group, an alkoxy group, a polyalkyleneoxyalkyl group, and an aryl group.

Examples of the number of carbon atoms in the above-described alkyl group (which may be linear, branched, or cyclic) and an alkyl group included in the above-described alkoxy group (which may be linear, branched, or cyclic) include 1 to 30, and 1 to 10 are preferable. In addition, the above-described alkyl group may further have a substituent, and examples of the substituent include a hydroxyl group and a halogen atom (including a fluorine atom, a chlorine atom, a bromine atom, an iodine atom, and the like).

The polyalkyleneoxyalkyl group is a substituent represented by R^{X6}(OR^{X7})ₚ(O)_{q}—. R^{X6} represents an alkyl group, R^{X7} represents an alkylene group, p represents an integer of 2 or more, and q represents 0 or 1.

The alkyl group represented by R^{X6} have the same definitions as the alkyl group represented by X^{A}. In addition, examples of the alkylene group represented by R^{X7} include a group obtained by removing one hydrogen atom from the alkyl group represented by X^{A}.

p is an integer of 2 or more, and the upper limit value thereof is, for example, 10 or less, preferably 5 or less.

Examples of the aryl group include an aryl group having 6 to 24 carbon atoms (which may be monocyclic or polycyclic).

The above-described aryl group may further have a substituent, and examples of the substituent include an alkyl group, a halogen atom, and a cyano group.

The above-described polyester chain preferably has a decyclized structure of a lactone such as ε-caprolactone, δ-caprolactone, β-propiolactone, γ-butyrolactone, δ-valerolactone, γ-valerolactone, enantholactone, β-butyrolactone, γ-hexanolactone, γ-octanolactone, δ-hexanolactone, δ-octanolactone, δ-dodecanolactone, α-methyl-γ-butyrolactone, and lactide (which may be an L-form or a D-form), and more preferably has a decyclized structure of ε-caprolactone or δ-valerolactone.

The resin having a repeating unit including a polyalkyleneimine structure and a polyester structure can be synthesized according to the synthesis method described in JP5923557B.

As the resin having a repeating unit including a polyalkyleneimine structure and a polyester structure, reference can be made to a resin having a repeating unit including a polyalkyleneimine structure and a polyester structure, which is described in JP5923557B, the contents of which are incorporated into the present specification.

A weight-average molecular weight of the resin A1 is not particularly limited, but for example, 3,000 or more is preferable, 4,000 or more is more preferable, 5,000 or more is still more preferable, and 6,000 or more is particularly preferable. In addition, the upper limit value thereof is, for example, preferably 300,000 or less, more preferably 200,000 or less, still more preferably 100,000 or less, and particularly preferably 50,000 or less.

### (Resin A2)

In addition, examples of another suitable aspect of the resin A include a resin including a repeating unit having a graft chain shown below (hereinafter, “resin A2”).

### Repeating Unit Having Graft Chain

As the repeating unit having a graft chain, the resin A2 preferably includes a repeating unit represented by any of Formulae (1) to (4), and more preferably includes a repeating unit represented by any of Formula (1A), Formula (2A), Formula (3A), Formula (3B), or Formula (4).

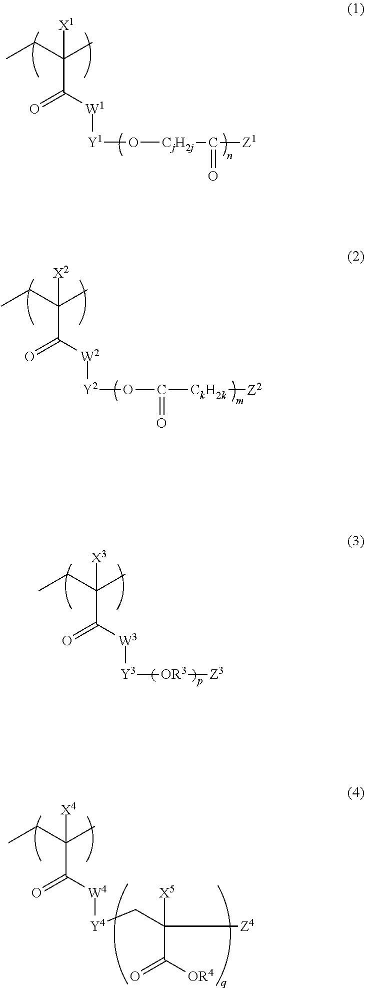

In Formulae (1) to (4), W¹, W², W³, and W⁴ each independently represent an oxygen atom or NH. W¹, W², W³, and W⁴ are preferably an oxygen atom.

In Formulae (1) to (4), X¹, X², X³, X⁴, and X⁵ each independently represent a hydrogen atom or a monovalent organic group. From the viewpoint of restriction on synthesis, X¹, X², X³, X⁴, and X⁵ are each independently preferably a hydrogen atom or an alkyl group having 1 to 12 carbon atoms (the number of carbon atoms), more preferably a hydrogen atom or a methyl group, and still more preferably a methyl group.

In Formulae (1) to (4), Y¹, Y², Y³, and Y⁴ each independently represent a divalent linking group, and the linking group has no particular restriction on a structure. Specific examples of the divalent linking groups represented by Y¹, Y², Y³, and Y⁴ include linking groups represented by the following (Y-1) to (Y-21). In the following structures, A and B each mean a bonding site bonded to the left terminal group and the right terminal group in Formulae (1) to (4). Among the structures shown below, from the viewpoint of simplicity of synthesis, (Y-21 or (Y-13) is more preferable.

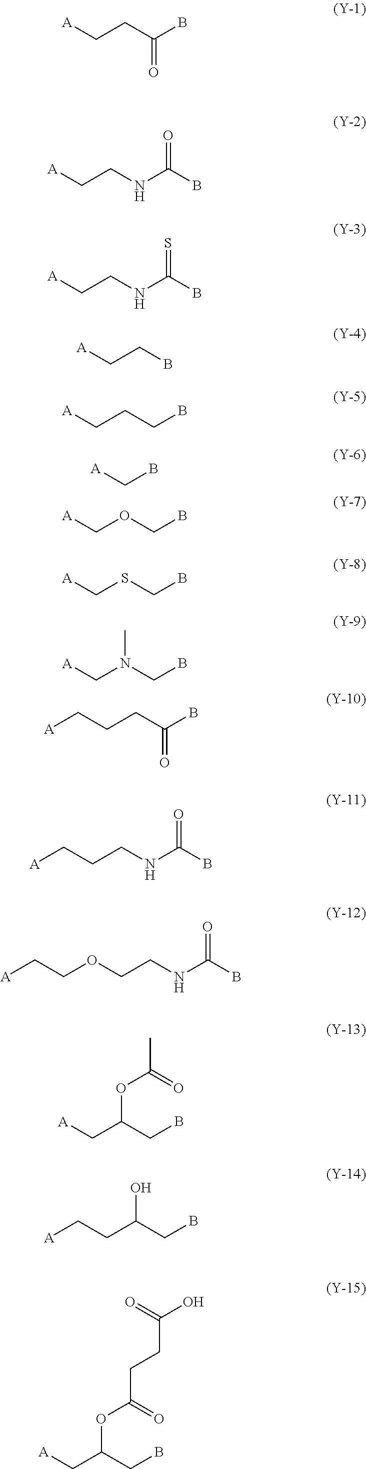

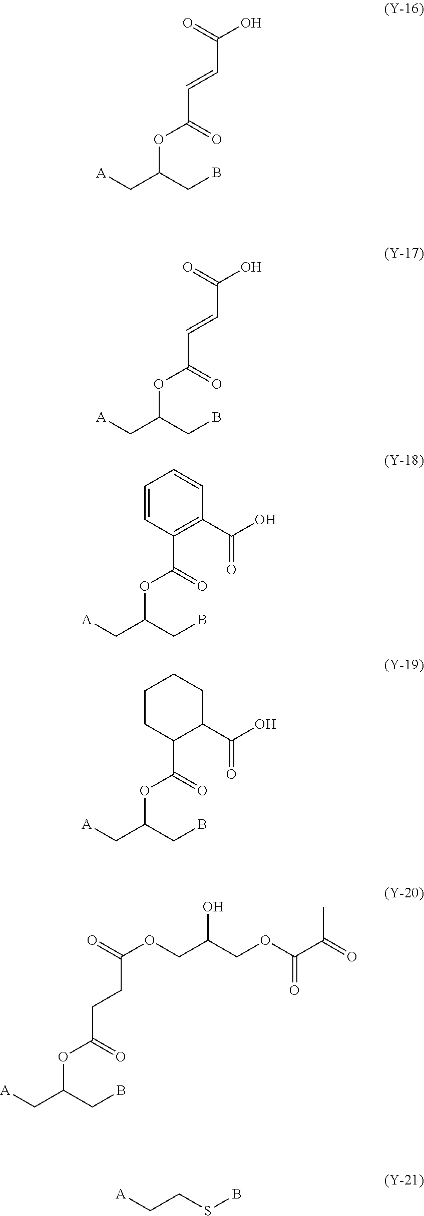

In Formulae (1) to (4), Z¹, Z², Z³, and Z⁴ each independently represent a hydrogen atom or a monovalent substituent. A structure of the above-described substituent is not particularly limited, but specific examples thereof include an alkyl group, a hydroxyl group, an alkoxy group, an aryloxy group, a heteroaryloxy group, an alkylthioether group, an arylthioether group, a heteroarylthioether group, and an amino group. Among these, particularly from the viewpoint of improvement in the dispersibility, the groups represented by Z¹, Z², Z³, and Z⁴ are each preferably a group exhibiting a steric repulsion effect, and more preferably each independently an alkyl group or alkoxy group having 5 to 24 carbon atoms, and, among them, in particular, still more preferably each independently a branched alkyl group having 5 to 24 carbon atoms, a cyclic alkyl group having 5 to 24 carbon atoms, or an alkoxy group having 5 to 24 carbon atoms. The alkyl group included in the alkoxy group may be linear, branched, or cyclic.

In addition, the substituent represented by Z¹, Z², Z³, and Z⁴ is also preferably a group containing a curable group such as a (meth)acryloyl group, an epoxy group, and/or an oxetanyl group. Examples of the above-described group containing a curable group include an “—O-alkylene group-(—O-alkylene group-)_{AL}-(meth)acryloyloxy group”. AL represents an integer of 0 to 5, and is preferably 1. The above-described alkylene groups preferably each independently have 1 to 10 carbon atoms. In a case where the above-described alkylene group has a substituent, the substituent is preferably a hydroxyl group.

The above-described substituent may be a group containing an onium structure.

The group containing an onium structure is a group having an anionic moiety and a cationic moiety. Examples of the anionic moiety include a partial structure containing an oxygen anion (—O⁻). Among these, the oxygen anion (—O⁻) is preferably directly bonded to a terminal of a repeating structure attached with n, m, p, or q in the repeating units represented by Formulae (1) to (4), and more preferably directly bonded to a terminal (that is, a right end in —(—O—CⱼH₂ⱼ—CO—)ₙ—) of a repeating structure attached with n in the repeating unit represented by Formula (1).

Examples of a cation of the cationic moiety of the group containing an onium structure include an ammonium cation. In a case where the cationic moiety is the ammonium cation, the cationic moiety is a partial structure containing a cationic nitrogen atom (>N⁺<). The cationic nitrogen atom (>N⁺<) is preferably bonded to four substituents (preferably, organic groups), and it is preferable that one to four among the substituents are each an alkyl group having 1 to 15 carbon atoms. In addition, it is also preferable that one or more (preferably, one) of the four substituents are a group containing a curable group such as a (meth)acryloyl group, an epoxy group, and/or an oxetanyl group. Examples of the above-described group containing a curable group, which can be adopted as the above-described substituent, include “—O-alkylene group-(—O-alkylene group-)_{AL}-(meth)acryloyloxy group” described above and “-alkylene group-(—O-alkylene group-)_{AL1}-(meth)acryloyloxy group”. AL1 represents an integer of 1 to 5, and is preferably 1. The above-described alkylene groups preferably each independently have 1 to 10 carbon atoms. In a case where the above-described alkylene group has a substituent, the substituent is preferably a hydroxyl group.

In Formulae (1) to (4), n, m, p, and q are each independently an integer of 1 to 500.

In addition, in Formulae (1) and (2), j and k each independently represent an integer of 2 to 8. Each of j and k in Formulae (1) and (2) is preferably an integer of 4 to 6, and more preferably 5.

In addition, in Formulae (1) and (2), each of n and m is, for example, an integer of 2 or more, preferably an integer of 6 or more, more preferably an integer of 10 or more, and still more preferably an integer of 20 or more. In addition, in a case where the resin A2 includes a polycaprolactone structure and a polyvalerolactone structure, the sum of the repetition number of the polycaprolactone structure and the repetition number of the polyvalerolactone structure is preferably an integer of 10 or more and more preferably an integer of 20 or more.

In Formula (3), R³ represents a branched or linear alkylene group, and is preferably an alkylene group having 1 to 10 carbon atoms and more preferably an alkylene group having 2 or 3 carbon atoms. In a case where p is 2 to 500, a plurality of R³'s may be the same or different from each other.

In Formula (4), R⁴ represents a hydrogen atom or a monovalent organic group, and the structure of the monovalent organic group is not particularly limited. As R⁴, a hydrogen atom, an alkyl group, an aryl group, or a heteroaryl group is preferable, and a hydrogen atom or an alkyl group is more preferable. In a case where R⁴ is an alkyl group, as the alkyl group, a linear alkyl group having 1 to 20 carbon atoms, a branched alkyl group having 3 to 20 carbon atoms, or a cyclic alkyl group having 5 to 20 carbon atoms is preferable, a linear alkyl group having 1 to 20 carbon atoms is more preferable, and a linear alkyl group having 1 to 6 carbon atoms is still more preferable. In a case where q in Formula (4) is 2 to 500, a plurality of X⁵'s and a plurality of R⁴'s in the graft chain may be the same or different from each other, respectively.

The resin A2 may include two or more repeating units having a graft chain, each of which has different structures. That is, the repeating units which are represented by Formulae (1) to (4) and have structures different from one another may be included in a molecule of the resin A2, and in a case where n, m, p, and q in Formulae (1) to (4) each represent an integer equal to or greater than 2, in Formulae (1) and (2), structures in which j and k are different from each other may be included in the side chain, and in Formulae (3) and (4), a plurality of R³'s, a plurality of R⁴'s, and a plurality of X⁵'s in the molecule may be respectively the same or different from each other.

The repeating unit represented by Formula (1) is more preferably a repeating unit represented by Formula (1A).

In addition, the repeating unit represented by Formula (2) is more preferably a repeating unit represented by Formula (2A).

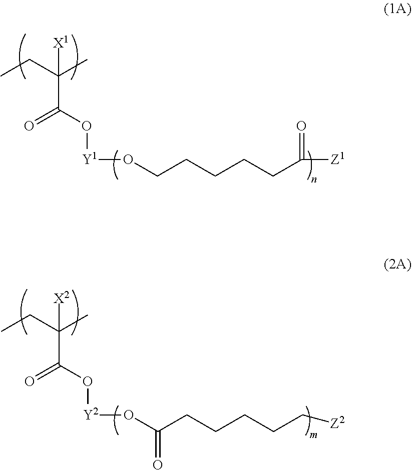

X¹, Y¹, Z¹, and n in Formula (1A) have the same definitions as X¹, Y¹, Z¹, and n in Formula (1), and preferred ranges thereof are also the same. X², Y², Z², and m in Formula (2A) have the same definitions as X², Y², Z², and m in Formula (2), and preferred ranges thereof are also the same.

In addition, the repeating unit represented by Formula (3) is more preferably a repeating unit represented by Formula (3A) or Formula (3B).

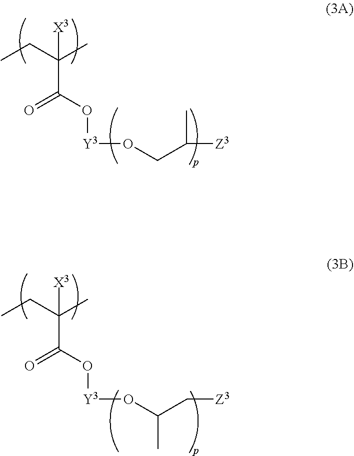

X³, Y³, Z³, and p in Formula (3A) or (3B) have the same definitions as X³, Y³, Z³, and p in Formula (3), and preferred ranges thereof are also the same.

It is more preferable that the resin A2 includes the repeating unit represented by Formula (1A) as the repeating unit having a graft chain.

In a case where the resin A2 includes the repeating unit represented by Formulae (1) to (4) described above, it is also preferable that the resin A further include, as another repeating unit having a graft chain, a repeating unit represented by Formula (5).

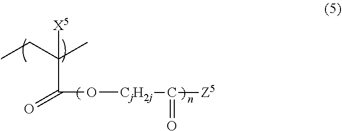

In Formula (5), n represents an integer of 1 to 50, preferably an integer of 2 to 30, more preferably an integer of 2 to 10, and still more preferably an integer of 2 to 5.

In addition, j represents an integer of 2 to 8, and preferably an integer of 4 to 6 and more preferably 5.

In addition, in Formula (5), X⁵ and Z⁵ have the same definitions as X¹ and Z¹ in Formula (1) respectively, and suitable aspects thereof are also the same.

In the resin A2, a content of the repeating unit having a graft chain in terms of mass is, for example, 2% to 100% by mass, preferably 2% to 95% by mass, more preferably 2% to 90% by mass, and still more preferably 5% to 30% by mass with respect to the total mass of the resin A2. The effect of the present invention is more excellent in a case where the repeating unit having a graft chain is contained in the range.

### Hydrophobic Repeating Unit

In addition, the resin A2 may include a hydrophobic repeating unit which is different from the repeating unit having a graft chain (that is, the hydrophobic repeating unit does not correspond to the repeating unit having a graft chain). Here, in the present specification, the hydrophobic repeating unit is a repeating unit which does not have an acid group (for example, a carboxylic acid group, a sulfonic acid group, a phosphoric acid group, a phenolic hydroxyl group, or the like).

The hydrophobic repeating unit is preferably a repeating unit derived from (corresponding to) a compound (monomer) having a C log P value of 1.2 or more, and more preferably a repeating unit derived from a compound having a C log P value of 1.2 to 8. By doing so, the effects of the present invention can be more reliably exhibited.

The C log P value is a value calculated by a program “C LOG P” available from Daylight Chemical Information System, Inc. This program provides a value of “calculated log P” calculated by the fragment approach (see the following documents) of Hansch and Leo. The fragment approach is based on a chemical structure of a compound, and the log P value of the compound is estimated by dividing the chemical structure into partial structures (fragments) and summing up degrees of contribution to log P which are assigned to the fragments. Details thereof are described in the following documents. In the present specification, a C log P value calculated by a program C LOG P v4.82 is used.

A. J. Leo, Comprehensive Medicinal Chemistry, Vol. 4, C. Hansch, P. G. Sammnens, J. B. Taylor and C. A. Ramsden, Eds., p. 295, Pergamon Press, 1990, C. Hansch & A. J. Leo. Substituent Constants For Correlation Analysis in Chemistry and Biology. John Wiley & Sons. A. J. Leo. Calculating log Poct from structure. Chem. Rev., 93, 1281 to 1306, 1993.

The log P refers to a common logarithm of a partition coefficient P, is a physical property value that shows how a certain organic compound is partitioned in an equilibrium of a two-phase system consisting of oil (generally, 1-octanol) and water by using a quantitative numerical value, and is expressed by the following expression.

log P=log(Coil/Cwater)

In the expression, Coil represents a molar concentration of a compound in an oil phase, and Cwater represents a molar concentration of the compound in a water phase.

The greater the positive log P value based on 0, the higher the oil solubility, and the greater the absolute value of negative log P, the higher the water solubility. Accordingly, the value of log P has a negative correlation with the water solubility of an organic compound and is widely used as a parameter for estimating the hydrophilicity and hydrophobicity of an organic compound.

The resin A2 preferably includes, as the hydrophobic repeating unit, one or more repeating units selected from repeating units derived from monomers represented by Formulae (i) to (iii).

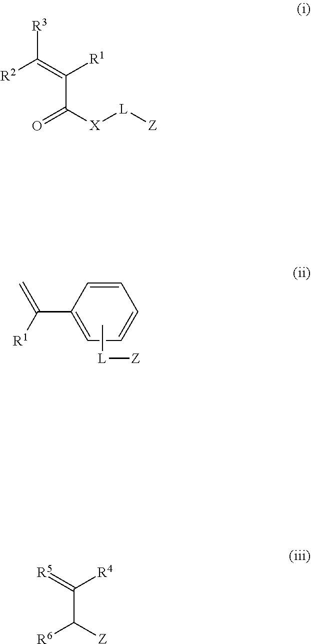

In Formulae (i) to (iii), R¹, R², and R³ each independently represent a hydrogen atom, a halogen atom (for example, a fluorine atom, a chlorine atom, a bromine atom, or the like), or an alkyl group (for example, a methyl group, an ethyl group, a propyl group, or the like) having 1 to 6 carbon atoms.

R¹, R², and R³ are each preferably a hydrogen atom or an alkyl group having 1 to 3 carbon atoms, and more preferably a hydrogen atom or a methyl group. R² and R³ are each still more preferably a hydrogen atom.

X represents an oxygen atom (—O—) or an imino group (—NH—), and is preferably an oxygen atom.

L is a single bond or a divalent linking group. Examples of the divalent linking group include a divalent aliphatic group (for example, an alkylene group, a substituted alkylene group, an alkenylene group, a substituted alkenylene group, an alkynylene group, or a substituted alkynylene group), a divalent aromatic group (for example, an arylene group or a substituted arylene group), a divalent heterocyclic group, an oxygen atom (—O—), a sulfur atom (—S—), an imino group (—NH—), a substituted imino group (—NR³¹—, where R³¹ is an aliphatic group, an aromatic group, or a heterocyclic group), a carbonyl group (—CO—), and a combination thereof.

The divalent aliphatic group may have a cyclic structure or a branched structure. The number of carbon atoms in the aliphatic group is preferably 1 to 20, more preferably 1 to 15, and still more preferably 1 to 10. The aliphatic group may be an unsaturated aliphatic group or a saturated aliphatic group, but is preferably a saturated aliphatic group. In addition, the aliphatic group may have a substituent. Examples of the substituent include a halogen atom, an aromatic group, and a heterocyclic group.

The number of carbon atoms in the divalent aromatic group is preferably 6 to 20, more preferably 6 to 15, and still more preferably 6 to 10. In addition, the aromatic group may have a substituent. Examples of the substituent include a halogen atom, an aliphatic group, an aromatic group, and a heterocyclic group.

It is preferable that the divalent heterocyclic group includes a 5-membered ring or a 6-membered ring as a heterocyclic ring. The heterocyclic ring may be fused with another heterocyclic ring, an aliphatic ring, or an aromatic ring. In addition, the heterocyclic group may have a substituent. Examples of the substituent include a halogen atom, a hydroxyl group, an oxo group (═O), a thioxo group (═S), an imino group (═NH), a substituted imino group (═N—R³², where R³² is an aliphatic group, an aromatic group, or a heterocyclic group), an aliphatic group, an aromatic group, and a heterocyclic group.

L is preferably a single bond, an alkylene group, or a divalent linking group having an oxyalkylene structure. The oxyalkylene structure is more preferably an oxyethylene structure or an oxypropylene structure. In addition, L may have a polyoxyalkylene structure which includes two or more repeating oxyalkylene structures. As the polyoxyalkylene structure, a polyoxyethylene structure or a polyoxypropylene structure is preferable. The polyoxyethylene structure is represented by —(OCH₂CH₂)ₙ—, and n is preferably an integer of 2 or more and more preferably an integer of 2 to 10.

Examples of Z include an aliphatic group (for example, an alkyl group, a substituted alkyl group, an unsaturated alkyl group, or a substituted unsaturated alkyl group), an aromatic group (for example, an aryl group, a substituted aryl group, an arylene group, or a substituted arylene group), a heterocyclic group, and a combination thereof. These groups may contain an oxygen atom (—O—), a sulfur atom (—S—), an imino group (—NH—), a substituted imino group (—NR³¹— where R³¹ is an aliphatic group, an aromatic group, or a heterocyclic group), or a carbonyl group (—CO—).

The aliphatic group may have a cyclic structure or a branched structure. The number of carbon atoms in the aliphatic group is preferably 1 to 20, more preferably 1 to 15, and still more preferably 1 to 10. The aliphatic group further contains a ring assembly hydrocarbon group or a crosslinked cyclic hydrocarbon group, and examples of the ring assembly hydrocarbon group include a bicyclohexyl group, a perhydronaphthalenyl group, a biphenyl group, and a 4-cyclohexylphenyl group. Examples of a crosslinked cyclic hydrocarbon ring include a bicyclic hydrocarbon ring such as pinane, bornane, norpinane, norbornane, and bicyclooctane rings (a bicyclo[2.2.2]octane ring, a bicyclo[3.2.1]octane ring, or the like); a tricyclic hydrocarbon ring such as homobredane, adamantane, tricyclo[5.2.1.0^{2,6}]decane, and tricyclo[4.3.1.1^{2,5}]undecane rings; and a tetracyclic hydrocarbon ring such as tetracyclo[4.4.0.1^{2,5}.1^{7,10}]dodecane and perhydro-1,4-methano-5,8-methanonaphthalene rings.

In addition, the crosslinked cyclic hydrocarbon ring also includes a fused cyclic hydrocarbon ring, for example, a fused ring in which a plurality of 5- to 8-membered cycloalkane rings, such as perhydronaphthalene (decalin), perhydroanthracene, perhydrophenanthrene, perhydroacenaphthene, perhydrofluorene, perhydroindene, and perhydrophenalene rings, are fused.

As the aliphatic group, a saturated aliphatic group is preferable to an unsaturated aliphatic group. In addition, the aliphatic group may have a substituent. Examples of the substituent include a halogen atom, an aromatic group, and a heterocyclic group. Here, the aliphatic group does not have an acid group as a substituent.

The number of carbon atoms in the aromatic group is preferably 6 to 20, more preferably 6 to 15, and still more preferably 6 to 10. In addition, the aromatic group may have a substituent. Examples of the substituent include a halogen atom, an aliphatic group, an aromatic group, and a heterocyclic group. Here, the aromatic group does not have an acid group as a substituent.

It is preferable that the heterocyclic group includes a 5-membered ring or a 6-membered ring as a heterocyclic ring. The heterocyclic ring may be fused with another heterocyclic ring, an aliphatic ring, or an aromatic ring. In addition, the heterocyclic group may have a substituent. Examples of the substituent include a halogen atom, a hydroxyl group, an oxo group (═O), a thioxo group (═S), an imino group (═NH), a substituted imino group (═N—R³², where R³² is an aliphatic group, an aromatic group, or a heterocyclic group), an aliphatic group, an aromatic group, and a heterocyclic group. Here, the heterocyclic group does not have an acid group as a substituent.

In Formula (iii), R⁴, R⁵, and R⁶ each independently represent a hydrogen atom, a halogen atom (for example, a fluorine atom, a chlorine atom, a bromine atom, or the like), an alkyl group (for example, a methyl group, an ethyl group, a propyl group, or the like) having 1 to 6 carbon atoms, Z, or L-Z. Here, L and Z have the same definitions as the groups described above. R⁴, R⁵, and R⁶ are each preferably a hydrogen atom or an alkyl group having 1 to 3 carbon atoms, and more preferably a hydrogen atom.

The monomer represented by Formula (i) is preferably a compound in which R¹, R², and R³ are each a hydrogen atom or a methyl group, L is a single bond, an alkylene group, or a divalent linking group having an oxyalkylene structure, X is an oxygen atom or an imino group, and Z is an aliphatic group, a heterocyclic group, or an aromatic group.

The monomer represented by Formula (ii) is preferably a compound in which R¹ is a hydrogen atom or a methyl group, L is an alkylene group, and Z is an aliphatic group, a heterocyclic group, or an aromatic group. In addition, the monomer represented by Formula (iii) is preferably a compound in which R⁴, R⁵, and R⁶ are each a hydrogen atom or a methyl group, and Z is an aliphatic group, a heterocyclic group, or an aromatic group.

Examples of typical compounds represented by Formulae (i) to (iii) include radically polymerizable compounds selected from acrylic acid esters, methacrylic acid esters, and styrenes.

Furthermore, regarding the examples of the typical compounds represented by Formulae (i) to (iii), reference can be made to the compounds described in paragraphs 0089 to 0093 of JP2013-249417A, the contents of which are incorporated into the present specification.

In the resin A2, a content of the hydrophobic repeating unit, in terms of mass is preferably 10% to 90% by mass and more preferably 20% to 80% by mass with respect to the total mass of the resin A2.

Functional Group Capable of Interacting with Magnetic Particles

The resin A2 preferably has a functional group capable of interacting with the magnetic particles.

It is preferable that the resin A2 further include a repeating unit including a functional group capable of interacting with the magnetic particles.

Examples of the functional group capable of interacting with the magnetic particles include an acid group, a basic group, a coordinating group, and a reactive functional group.

In a case where the resin A2 includes an acid group, a basic group, a coordinating group, or a reactive functional group, it is preferable that the resin A2 includes a repeating unit including an acid group, a repeating unit including a basic group, a repeating unit including a coordinating group, or a repeating unit including a reactive functional group, respectively.

The repeating unit including an acid group may be a repeating unit which is the same or different from the above-described repeating unit having a graft chain. However, the repeating unit including an acid group is a repeating unit different from the above-described hydrophobic repeating unit (that is, the repeating unit including an acid group does not correspond to the above-described hydrophobic repeating unit).

Examples of the acid group which is the functional group capable of interacting with the magnetic particles include a carboxylic acid group, a sulfonic acid group, a phosphoric acid group, and a phenolic hydroxyl group; and at least one of a carboxylic acid group, a sulfonic acid group, or a phosphoric acid group is preferable, and a carboxylic acid group is more preferable.

The resin A2 may have one or two or more kinds of the repeating unit including an acid group.

In a case where the resin A2 includes a repeating unit including an acid group, a content thereof in terms of mass is preferably 5% to 80% by mass and more preferably 10% to 60% by mass with respect to the total mass of the resin A2.

Examples of the basic group which is the functional group capable of interacting with the magnetic particles include an amino group (a group obtained by removing one hydrogen atom from ammonia, a primary amine, or a secondary amine), a heterocyclic ring including an N atom, and an amide group; and from the viewpoint of favorable adhesion force to the magnetic particles and high dispersibility, an amino group is preferable.

The resin A2 may include one or two or more kinds of the basic group.

In a case where the resin A2 includes a repeating unit including a basic group, a content thereof in terms of mass is preferably 0.01% to 50% by mass and more preferably 0.01% to 30% by mass with respect to the total mass of the resin A2.

Examples of the coordinating group and the reactive functional group which are the functional groups capable of interacting with the magnetic particles include an acetyl acetoxy group, a trialkoxysilyl group, an isocyanate group, an acid anhydride, and an acid chloride. Among these, as the coordinating group and the reactive functional group, an acetylacetoxy group is preferable from the viewpoint that the adsorption force to the magnetic particles is favorable and the dispersibility of the magnetic particles is high.

The resin A2 may have one or two or more kinds of the coordinating group and the reactive functional group.

In a case where the resin A2 includes the repeating unit including a coordinating group and/or the repeating unit including a reactive functional group, a content thereof in terms of mass is preferably 10% to 80% by mass and more preferably 20% to 60% by mass with respect to the total mass of the resin A2.

In a case where the above-described resin A2 includes a functional group capable of interacting with the magnetic particles, in addition to the graft chain, it is sufficient that the resin A2 includes the functional group capable of interacting with various magnetic particles described above, and a method of introducing these functional groups is not particularly limited. As the above-described resin A2, for example, an aspect in which the resin A2 includes one or more kinds of repeating units selected from repeating units derived from monomers represented by Formulae (iv) to (vi) is also preferable.

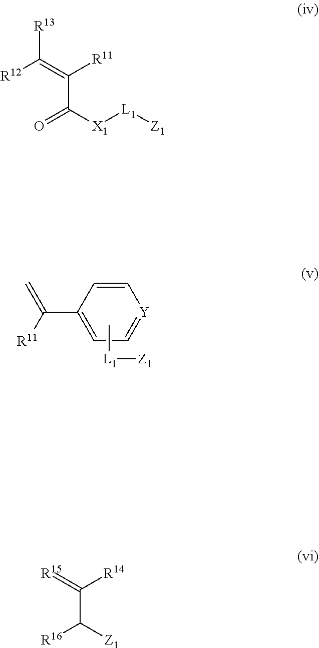

In Formulae (iv) to (vi), R^{D}, R¹², and R¹³ each independently represent a hydrogen atom, a halogen atom (for example, a fluorine atom, a chlorine atom, a bromine atom, or the like), or an alkyl group (for example, a methyl group, an ethyl group, a propyl group, or the like) having 1 to 6 carbon atoms.

In Formulae (iv) to (vi), R¹¹, R¹², and R¹³ are each preferably a hydrogen atom or an alkyl group having 1 to 3 carbon atoms, and more preferably a hydrogen atom or a methyl group. In General Formula (iv), R¹² and R¹³ are each still more preferably a hydrogen atom.

In Formula (iv), X₁ represents an oxygen atom (—O—) or an imino group (—NH—), and is preferably an oxygen atom.

In addition, in Formula (v), Y represents a methine group or a nitrogen atom.

In addition, in Formulae (iv) and (v), L₁ represents a single bond or a divalent linking group. The divalent linking group has the same definition as the divalent linking group represented by L in Formula (i) described above.

L₁ is preferably a single bond, an alkylene group, or a divalent linking group having an oxyalkylene structure. The oxyalkylene structure is more preferably an oxyethylene structure or an oxypropylene structure. In addition, L₁ may have a polyoxyalkylene structure which includes two or more repeating oxyalkylene structures. As the polyoxyalkylene structure, a polyoxyethylene structure or a polyoxypropylene structure is preferable. The polyoxyethylene structure is represented by —(OCH₂CH₂)ₙ—, and n is preferably an integer of 2 or more and more preferably an integer of 2 to 10.

In Formulae (iv) and (vi), Z₁ represents a functional group which can interact with the magnetic particles in addition to the graft chain, and a carboxylic acid group or an amino group is preferable.

In Formula (vi), R¹⁴, R¹⁵, and R¹⁶ each independently represent a hydrogen atom, a halogen atom (for example, a fluorine atom, a chlorine atom, a bromine atom, or the like), an alkyl group (for example, a methyl group, an ethyl group, a propyl group, or the like) having 1 to 6 carbon atoms, —Z₁, or L₁-Z₁. Here, L₁ and Z₁ have the same definitions as L₁ and Z₁ described above, and preferred examples thereof are also the same. R¹⁴, R¹⁵, and R¹⁶ are each preferably a hydrogen atom or an alkyl group having 1 to 3 carbon atoms, and more preferably a hydrogen atom.

The monomer represented by Formula (iv) is preferably a compound in which R¹¹, R¹², and R¹³ are each independently a hydrogen atom or a methyl group, L₁ is an alkylene group or a divalent linking group having an oxyalkylene structure, X₁ is an oxygen atom or an imino group, and Z₁ is a carboxylic acid group.

In addition, the monomer represented by Formula (v) is preferably a compound in which R¹¹ is a hydrogen atom or a methyl group, L₁ is an alkylene group, Z₁ is a carboxylic acid group, and Y is a methine group.

Furthermore, the monomer represented by Formula (vi) is preferably a compound in which R¹⁴, R¹⁵, and R¹⁶ are each independently a hydrogen atom or a methyl group and Z₁ is a carboxylic acid group.

Typical examples of the monomers (compounds) represented by Formulae (iv) to (vi) are shown below.

Examples of the monomers include methacrylic acid, crotonic acid, isocrotonic acid, a reaction product of a compound (for example, 2-hydroxyethyl methacrylate) including an addition polymerizable double bond and a hydroxyl group in a molecule with a succinic acid anhydride, a reaction product of a compound containing an addition polymerizable double bond and a hydroxyl group in a molecule with a phthalic acid anhydride, a reaction product of a compound containing an addition polymerizable double bond and a hydroxyl group in a molecule with a tetrahydroxyphthalic acid anhydride, a reaction product of a compound including an addition polymerizable double bond and a hydroxyl group in a molecule with trimellitic acid anhydride, a reaction product of a compound including an addition polymerizable double bond and a hydroxyl group in a molecule with a pyromellitic acid anhydride, acrylic acid, an acrylic acid dimer, an acrylic acid oligomer, maleic acid, itaconic acid, fumaric acid, 4-vinylbenzoic acid, vinyl phenol, and 4-hydroxyphenyl methacrylamide.

From the viewpoint of interaction with the magnetic particles, temporal stability, and permeability to the developer, a content of the repeating unit a functional group capable of interacting with the magnetic particles in terms of mass is preferably 0.05% to 90% by mass, more preferably 1.0% to 80% by mass, and still more preferably 10% to 70% by mass with respect to the total mass of the resin A2.

### Ethylenically Unsaturated Group

The resin A2 may include an ethylenically unsaturated group.

The ethylenically unsaturated group is not particularly limited, and examples thereof include a (meth)acryloyl group, a vinyl group, and a styryl group; and a (meth)acryloyl group is preferable.

Among these, the resin A2 preferably includes a repeating unit which includes an ethylenically unsaturated group on a side chain; and more preferably includes a repeating unit which includes an ethylenically unsaturated group on a side chain and is derived from (meth)acrylate (hereinafter, also referred to as “(meth)acrylic repeating unit including an ethylenically unsaturated group on a side chain”).

The (meth)acrylic repeating unit including an ethylenically unsaturated group on a side chain is obtained, for example, by causing an addition reaction between the above-described carboxylic acid group in the resin A2 including a (meth)acrylic repeating unit including the carboxylic acid group and an ethylenically unsaturated compound including a glycidyl group or an alicyclic epoxy group. The (meth)acrylic repeating unit including an ethylenically unsaturated group on a side chain can be obtained by reacting the ethylenically unsaturated group (glycidyl group or alicyclic epoxy group) introduced in this manner.

In a case where the resin A2 includes a repeating unit including an ethylenically unsaturated group, a content thereof in terms of mass is preferably 30% to 70% by mass and more preferably 40% to 60% by mass with respect to the total mass of the resin A2.

### Other Curable Groups

The resin A2 may include a curable group in addition to the ethylenically unsaturated group.

Examples of other curable groups include an epoxy group and an oxetanyl group.

Among these, the resin A2 preferably includes a repeating unit which includes the other curable groups on a side chain; and more preferably includes a repeating unit which includes the other curable groups on a side chain and is derived from (meth)acrylate (hereinafter, also referred to as “(meth)acrylic repeating unit including the other curable groups on a side chain”).

Examples of the (meth)acrylic repeating unit including the other curable groups on a side chain include a repeating unit derived from glycidyl (meth)acrylate.

In a case where the resin A2 includes a repeating unit including other curable groups, a content thereof in terms of mass is preferably 5% to 50% by mass and more preferably 10% to 30% by mass with respect to the total mass of the resin A2.

### Other Repeating Units

Furthermore, for the purpose of improving various performances such as a film forming ability, as long as the effect of the present invention is not impaired, the resin A2 may further have other repeating units having various functions, which are different from the above-mentioned repeating units.

Examples of such other repeating units include repeating units derived from radically polymerizable compounds selected from acrylonitriles, methacrylonitriles, and the like.

For the resin A2, one or two or more kinds of the other repeating units can be used, and a content thereof in terms of mass is preferably 0% to 80% by mass and more preferably 10% to 60% by mass with respect to the total mass of the resin A2.

### Physical Properties of Resin A2

An acid value of the resin A2 is not particularly limited, but is, for example, preferably in a range of 0 to 400 mgKOH/g, more preferably in a range of 10 to 350 mgKOH/g, still more preferably in a range of 30 to 300 mgKOH/g, and particularly preferably in a range of 50 to 200 mgKOH/g.

In a case where the acid value of the resin A2 is 50 mgKOH/g or more, sedimentation stabilization of the magnetic particles can be further improved.

In the present specification, the acid value can be calculated, for example, from the average content of acid groups in the compound. In addition, a resin having a desired acid value can be obtained by changing the content of the repeating unit including an acid group in the resin.

A weight-average molecular weight of the resin A2 is not particularly limited, but for example, 3,000 or more is preferable, 4,000 or more is more preferable, 5,000 or more is still more preferable, and 6,000 or more is particularly preferable. In addition, the upper limit value thereof is, for example, preferably 300,000 or less, more preferably 200,000 or less, still more preferably 100,000 or less, and particularly preferably 50,000 or less.

The resin A2 can be synthesized based on a known method.

Regarding specific examples of the resin A2, reference can be made to the polymer compound described in paragraphs 0127 to 0129 of JP2013-249417A, the contents of which are incorporated into the present specification.

As the resin A2, graft copolymers in paragraphs 0037 to 0115 of JP2010-106268A (corresponding to paragraphs 0075 to 0133 of US2011/0124824) can also be used, the contents of which are incorporated into the present specification.

The dispersant may be used alone or in combination of two or more kinds thereof.

In a case where the composition contains a dispersant, a content of the dispersant (in a case where a plurality of types of dispersants are contained, the total content thereof) is preferably 0.001% to 20.0% by mass, more preferably 0.01% to 15.0% by mass, still more preferably 0.05% to 10.0% by mass, and particularly preferably 0.05% to 5.0% by mass with respect to the total mass of the composition.

In a case where the composition contains a dispersant, the content of the dispersant (in a case where a plurality of types of dispersants are contained, the total content thereof) is preferably 0.001% to 20.0% by mass, more preferably 0.01% to 15.0% by mass, still more preferably 0.05% to 10.0% by mass, and particularly preferably 0.05% to 5.0% by mass with respect to the total solid content of the composition.

### [Rheology Control Agent]

The composition may contain a rheology control agent.

The rheology control agent is a component which imparts thixotropic properties to the composition, in which high viscosity is exhibited in a case where a shearing force (shear rate) is low and low viscosity is exhibited in a case where a shear force (shear rate) is high.

In a case where the composition contains a rheology control agent, a content of the rheology control agent is preferably 0.01 to 10% by mass, more preferably 0.01 to 8.0% by mass, and still more preferably 0.01 to 6.0% by mass with respect to the total mass of the composition.

The content of the rheology control agent is preferably 0.01% to 10% by mass, more preferably 0.01% to 8.0% by mass, and still more preferably 0.01% to 6.0% by mass with respect to the total solid content of the composition.

Examples of the rheology control agent include an organic rheology control agent and an inorganic rheology control agent, and an organic rheology control agent is preferable.

### <Organic Rheology Control Agent>

In a case where the composition contains an organic rheology control agent, a content of the organic rheology control agent is preferably 0.01 to 10% by mass, more preferably 0.01 to 8.0% by mass, and still more preferably 0.01 to 6.0% by mass with respect to the total mass of the composition.

The content of the organic rheology control agent is preferably 0.01% to 10% by mass, more preferably 0.01% to 8.0% by mass, and still more preferably 0.01% to 6.0% by mass with respect to the total solid content of the composition.

The organic rheology control agent may be used alone or in combination of two or more kinds thereof.

Examples of the organic rheology control agent include a compound having one or more (preferably two or more) adsorptive groups and further having a steric repulsion structural group.

The adsorptive group interacts with the surface of the magnetic particles to adsorb the organic rheology control agent to the surface of the magnetic particles.

Examples of the above-described adsorptive group include an acid group, a basic group, and an amide group.

Examples of the acid group include a carboxy group, a phosphoric acid group, a sulfo group, a phenolic hydroxyl group, and an acid anhydride group thereof (an acid anhydride group of a carboxy group or the like), and from the viewpoint that the effect of the present invention is more excellent, a carboxy group is preferable.

Examples of the basic group include an amino group (a group obtained by removing one hydrogen atom from ammonia, a primary amine, or a secondary amine) and an imino group.

Among these, as the adsorptive group, a carboxy group or an amide group is preferable, and a carboxy group is more preferable.

Since the steric repulsion structural group has a sterically bulky structure, steric hindrance is introduced into the magnetic particles to which the organic rheology control agent is adsorbed, and an appropriate space is maintained between the magnetic particles. As the steric repulsion structural group, for example, a chain-like group is preferable, a long-chain fatty acid group is more preferable, and a long-chain alkyl group is still more preferable.

It is also preferable that the organic rheology control agent has a hydrogen-bonding unit.

The hydrogen-bonding unit is a partial structure which functions to construct a hydrogen-bonding network between the organic rheology control agents and between the organic rheology control agent and other components. The organic rheology control agent contributing to the formation of the network may or may not be adsorbed to the surface of the magnetic particles.

The hydrogen-bonding unit may be the same as or different from the above-described adsorptive group. In a case where the hydrogen-bonding unit is the same as the above-described adsorptive group, a part of the above-described adsorptive group is bonded to the surface of the magnetic particles, and another part functions as the hydrogen-bonding unit.

As the hydrogen-bonding unit, a carboxy group or an amide group is preferable. As the hydrogen-bonding unit, the carboxy group is preferable from the viewpoint that the carboxy group is easily incorporated into a curing reaction of the specific binder in a case of producing the magnetic material, and the amide group is preferable from the viewpoint that temporal stability of the composition is more excellent.

In a case where the organic rheology control agent is a resin, the organic rheology control agent which is a resin may have the above-described repeating unit having a graft chain, which can be contained in the dispersant, or may not substantially have the repeating unit having a graft chain. In a case where the organic rheology control agent which is a resin does not have the above-described repeating unit having a graft chain, which can be contained in the dispersant, a content of the above-described repeating unit having a graft chain is preferably less than 2% by mass, more preferably 1% by mass or less, and still more preferably less than 0.1% by mass with respect to the total mass of the organic rheology control agent which is a resin. The lower limit thereof is 0% by mass or more.

The organic rheology control agent is preferably one or more selected from the group consisting of a polycarboxylic acid (a compound having two or more carboxy groups), a polycarboxylic acid anhydride (a compound having two or more acid anhydride groups composed of carboxy groups), and an amide wax.

These compounds may be a resin or may be other than a resin.

In addition, these compounds may correspond to an aggregation control agent and/or an aggregation dispersant, which will be described later.

Examples of the organic rheology control agent include modified urea, urea-modified polyamide, fatty acid amide, polyurethane, polyamide amide, a polymer urea derivative, and salts thereof (carboxylic acid salts and the like).

The modified urea is a reaction product of an isocyanate monomer or an adduct thereof with an organic amine. The modified urea is modified with a polyoxyalkylene polyol (polyoxyethylene polyol, polyoxypropylene polyol, or the like) and/or an alkyd chain or the like. The urea-modified polyamide is, for example, a compound having a urea bond and a compound having a moderate polar group or a low polar group at a terminal. Examples of the moderate polar group or the low polar group include a polyoxyalkylene polyol (polyoxyethylene polyol, polyoxypropylene polyol, or the like) and an alkyd chain. The fatty acid amide is a compound having a long-chain fatty acid group and an amide group in the molecule.

These compounds may be a resin or may be other than a resin.

In addition, these compounds may correspond to an aggregation control agent and/or an aggregation dispersant, which will be described later.

A molecular weight (in a case of having a molecular weight distribution, a weight-average molecular weight) of the organic rheology control agent is preferably in a range of 200 to 50,000.

In a case where the organic rheology control agent has an acid value, the acid value is preferably 5 to 400 mgKOH/g.

In a case where the organic rheology control agent has an amine value, the amine value is preferably 5 to 300 mgKOH/g.

### (Aggregation Control Agent)

Examples of the organic rheology control agent also include an aggregation control agent. The aggregation control agent may be a resin or may be other than a resin.

The aggregation control agent has a function of being bonded to an aggregate having a relatively high density, such as the magnetic particles, and of further dispersing a component such as the specific binder in the composition, so that it is possible to produce a bulky aggregate.

In a case where the composition contains an aggregation control agent, re-dispersibility can be improved since hard cake formation of the magnetic particles in the composition is suppressed and a bulky aggregate is formed.

Examples of the aggregation control agent include a cellulose derivative.

Examples of the cellulose derivative include carboxymethyl cellulose, methyl cellulose, hydroxyethyl cellulose, hydroxypropyl cellulose, hydroxypropylmethyl cellulose, hydroxypropylethyl cellulose, and salts thereof.

In a case where the composition contains an aggregation control agent, a content of the aggregation control agent is preferably 0.01 to 10% by mass, more preferably 0.01 to 8.0% by mass, and still more preferably 0.01 to 6.0% by mass with respect to the total mass of the composition.

The content of the aggregation control agent is preferably 0.01% to 10% by mass, more preferably 0.01% to 8.0% by mass, and still more preferably 0.01% to 6.0% by mass with respect to the total solid content of the composition.

### (Aggregation Dispersant)

Examples of the organic rheology control agent also include an aggregation dispersant.

The aggregation dispersant may be a resin or may be other than a resin.

The aggregation dispersant has a function of being adsorbed on the surface of the magnetic particles, maintaining a distance between the magnetic particles at a certain level or more due to interaction between the dispersants while separating the magnetic particles from each other, and preventing the magnetic particles from being directly aggregated. As a result, aggregation of the magnetic particles is suppressed, and an aggregate having a relatively low density is formed even in a case where the aggregate is formed. Furthermore, since the component such as the specific binder is dispersed in the composition, it is possible to form a bulky aggregate, and thus the re-dispersibility can be improved.

As the aggregation dispersant, an alkylolammonium salt of a polybasic acid is preferable.

The polybasic acid may have two or more acid groups, and examples thereof include acidic polymers including a repeating unit having an acid group (for example, polyacrylic acid, polymethacrylic acid, polyvinylsulfonic acid, and polyphosphoric acid). In addition, examples of the polybasic acid other than those described above include polymers obtained by polymerizing an unsaturated fatty acid such as crotonic acid. The alkylolammonium salt of a polybasic acid is obtained by reacting these polybasic acids with alkylolammonium. The salt obtained by such a reaction usually includes the following partial structure.

—C(═O)—N(—R¹)(—R²—OH)

Here, R¹ is an alkyl group and R² is an alkylene group.

As the alkylolammonium salt of a polybasic acid, a polymer including a plurality of the above-described partial structures is preferable. In a case where the alkylolammonium salt of a polybasic acid is a polymer, a weight-average molecular weight is preferably 1,000 to 100,000 and more preferably 5,000 to 20,000. The polymer of the alkylolammonium salt of a polybasic acid is bonded to the surface of the magnetic particles and forms a hydrogen bond with another aggregation dispersant molecule such that the main chain structure of the polymer enters between the magnetic particles, and thus the magnetic particles can be separated from each other.

Examples of one suitable aspect of the aggregation dispersant include an amide wax which is a condensate obtained by a dehydration condensation of (a) saturated aliphatic monocarboxylic acids and hydroxy group-containing aliphatic monocarboxylic acids, (b) at least one acid of the polybasic acids, and (c) at least one amine of diamines and tetramines.

It is preferable that (a) to (c) are used such that a molar ratio of (a):(b):(c) is 1 to 3:0 to 5:1 to 6.

The number of carbon atoms in the saturated aliphatic monocarboxylic acids is preferably 12 to 22. Specific examples thereof include lauric acid, myristic acid, pentadecyl acid, palmitic acid, margaric acid, stearic acid, nonadecanoic acid, arachidic acid, and behenic acid.

The number of carbon atoms in the hydroxy group-containing aliphatic monocarboxylic acids is preferably 12 to 22. Specific examples thereof include 12-hydroxystearic acid and dihydroxystearic acid.

These saturated aliphatic monocarboxylic acids and hydroxy group-containing aliphatic monocarboxylic acids may be used alone or in combination of a plurality thereof.

The polybasic acid is preferably a carboxylic acid which is a dicarboxylic acid or higher and has 2 to 12 carbon atoms, and more preferably a dicarboxylic acid.

Examples of such a dicarboxylic acid include aliphatic dicarboxylic acids such as oxalic acid, malonic acid, succinic acid, glutaric acid, adipic acid, pimelic acid, suberic acid, azelaic acid, sebacic acid, 1,10-decanedicarboxylic acid, and 1,12-dodecanedicarboxylic acid; aromatic dicarboxylic acids such as phthalic acid, isophthalic acid, and terephthalic acid; and alicyclic dicarboxylic acids such as 1,2-cyclohexanedicarboxylic acid, 1,3-cyclohexanedicarboxylic acid, 1,4-cyclohexanedicarboxylic acid, and cyclohexylsuccinic acid. These polybasic acids may be used alone or in combination of a plurality thereof.

The number of carbon atoms in the diamines is preferably 2 to 14. Specific examples thereof include ethylenediamine, 1,3-propanediamine, 1,4-butanediamine, hexamethylenediamine, metaxylenediamine, tolylenediamine, paraxylenediamine, phenylenediamine, isophoronediamine, 1,10-decanediamine, 1,12-dodecanediamine, 4,4-diaminodicyclohexyl methane, and 4,4-diaminodiphenyl methane.

The number of carbon atoms in the tetramines is preferably 2 to 14. Specific examples thereof include butane-1,1,4,4-tetramine, and pyrimidine-2, 4,5,6-tetramine. These diamines and tetramines may be used alone or in combination of a plurality thereof.

Amounts of the diamines and the tetramines are adjusted according to the number of moles of the saturated aliphatic monocarboxylic acid or the hydroxy group-containing aliphatic monocarboxylic acid and the number of moles of the polybasic acids, so that the total number of carboxy groups and the total number of amino groups are equivalent. For example, in a case of n mol (n=0 to 5) of an aliphatic dicarboxylic acid which is the polybasic acids with respect to 2 mol of an aliphatic monocarboxylic acid, and the diamines is (n+1) mol, the acid and the amine are equivalent.

The amide wax may be obtained as a mixture of a plurality of compounds having different molecular weights. The amide wax is preferably a compound represented by Chemical Formula (I). The amide wax may be a single compound or a mixture.

A-C—(B—C)ₘ-A (I)

In Formula (I), A is a dehydrated residual group of the saturated aliphatic monocarboxylic acid and/or the hydroxy group-containing aliphatic monocarboxylic acid, B is a dehydrated residual group of the polybasic acid, C is a dehydrogenated residual group of the diamine and/or the tetramine, and m is 0≤m≤5.

Examples of one suitable aspect of the aggregation dispersant include a compound represented by Formula (II).

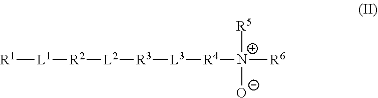

In Formula (II), R¹ represents a monovalent linear aliphatic hydrocarbon group having 10 to 25 carbon atoms, R² and R³ each independently represent a divalent aliphatic hydrocarbon group having 2, 4, 6, or 8 carbon atoms, a divalent alicyclic hydrocarbon group having 6 carbon atoms, or a divalent aromatic hydrocarbon group, R⁴ represents a divalent aliphatic hydrocarbon group having 1 to 8 carbon atoms, and R⁵ and R⁶ each independently represent a monovalent aliphatic hydrocarbon group having 1 to 3 carbon atoms or a hydroxyalkyl ether group.

In Formula (II), L¹ to L³ each independently represent an amide bond, and in a case where L¹ and L³ are each —CONH—, L² is —NHCO—, and in a case where L¹ and L³ are each —NHCO—, L² is —CONH—.

R¹ is a monovalent linear aliphatic hydrocarbon group having 10 to 25 carbon atoms, and examples thereof include a linear alkyl group such as a decyl group, a lauryl group, a myristyl group, a pentadecyl group, a stearyl group, a palmityl group, a nonadecyl group, an eicosyl group, and a behenyl group; a linear alkenyl group such as a decenyl group, a pentadecenyl group, an oleyl group, and an eicosenyl group; and a linear alkynyl group such as a pentadecynyl group, an octadecynyl group, and a nonadecinyl group.

Among these, R¹ is preferably a monovalent linear aliphatic hydrocarbon group having 14 to 25 carbon atoms, and more preferably a monovalent linear aliphatic hydrocarbon group having 18 to 21 carbon atoms. The linear aliphatic hydrocarbon group is preferably an alkyl group.

Examples of the divalent aliphatic hydrocarbon group having 2, 4, 6, or 8 carbon atoms in R² and R³ include an ethylene group, an n-butylene group, an n-hexylene group, and an n-octylene group.

Examples of the divalent alicyclic hydrocarbon group having 6 carbon atoms in R² and R³ include a 1,4-cyclohexylene group, a 1,3-cyclohexylene group, and a 1,2-cyclohexylene group.

Examples of the divalent aromatic hydrocarbon group in R² and R³ include an arylene group having 6 to 10 carbon atoms, such as a 1,4-phenylene group, a 1,3-phenylene group, and a 1,2-phenylene group.

Among these, from the viewpoint that an effect of improving viscosity is excellent, R² and R³ are each preferably a divalent aliphatic hydrocarbon group having 2, 4, 6, or 8 carbon atoms, more preferably a divalent aliphatic hydrocarbon group having 2, 4, or 6 carbon atoms, still more preferably a divalent aliphatic hydrocarbon group having 2 or 4 carbon atoms, and even more preferably a divalent aliphatic hydrocarbon group having 2 carbon atoms. The divalent aliphatic hydrocarbon group is preferably a linear alkylene group.

R⁴ represents a divalent aliphatic hydrocarbon group having 1 to 8 carbon atoms, and among these, from the viewpoint that the effect of improving viscosity is excellent, a linear or branched alkylene group is preferable, and a linear alkylene group is more preferable.

In addition, the number of carbon atoms in the divalent aliphatic hydrocarbon group in R⁴ is 1 to 8, and from the viewpoint that the effect of improving viscosity is excellent, it is preferably 1 to 7, more preferably 3 to 7, still more preferably 3 to 6, and particularly preferably 3 to 5.

Accordingly, R⁴ is preferably a linear or branched alkylene group having 1 to 8 carbon atoms, more preferably a linear alkylene group having 1 to 7 carbon atoms, still more preferably a linear alkylene group having 3 to 7 carbon atoms, particularly preferably a linear alkylene group having 3 to 6 carbon atoms, and most preferably a linear alkylene group having 3 to 5 carbon atoms.

Examples of the monovalent aliphatic hydrocarbon group having 1 to 3 carbon atoms in R⁵ and R⁶ include a linear or branched alkyl group having 1 to 3 carbon atoms, such as a methyl group, an ethyl group, a propyl group, and an isopropyl group; a linear or branched alkenyl group having 2 or 3 carbon atoms, such as a vinyl group, a 1-methylvinyl group, and a 2-propenyl group; and a linear or branched alkynyl group having 2 or 3 carbon atoms, such as an ethynyl group and a propynyl group.

Examples of the hydroxyalkyl ether group in R⁵ and R⁶ include a mono- or di(hydroxy) C₁₋₃ alkyl ether group such as a 2-hydroxyethoxy group, a 2-hydroxypropoxy group, and a 2,3-dihydroxypropoxy group.

Among these, R⁵ and R⁶ are each independently preferably a monovalent aliphatic hydrocarbon group having 1 to 3 carbon atoms, more preferably a linear or branched alkyl group having 1 to 3 carbon atoms, still more preferably a linear alkyl group having 1 to 3 carbon atoms, and particularly preferably a methyl group.

As the compound represented by Formula (II), compounds represented by Formulae (II-1) to (II-9) are preferable.

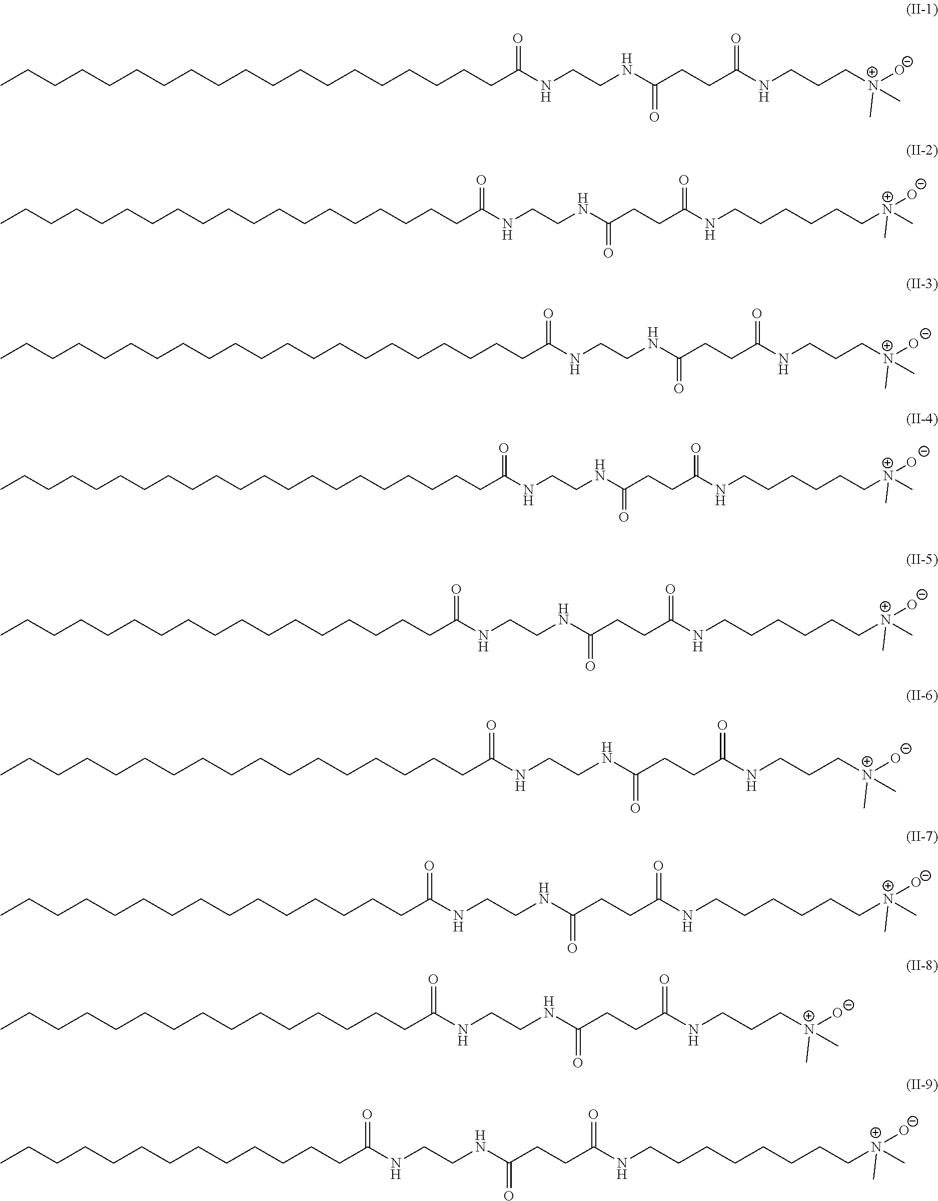

Examples of the aggregation dispersant include ANTI-TERRA-203, 204, 206, and 250 (all trade names, manufactured by BYK-Chemie GmbH); ANTI-TERRA-U (trade name, manufactured by BYK-Chemie GmbH); DISPER BYK-102, 180, and 191 (all trade names, manufactured by BYK-Chemie GmbH); BYK-P105 (trade name, manufactured by BYK-Chemie GmbH); TEGO Disper 630 and 700 (all trade names, manufactured by Evonik Degussa Japan Co., Ltd.); Talen VA-705B (trade name, manufactured by KYOEISHA CHEMICAL CO., LTD.); and FLOWNON RCM-100, RCM-300 TL, and RCM-230AF (trade name, manufactured by KYOEISHA CHEMICAL CO., LTD., amide wax).

In a case where the composition contains an aggregation dispersant, a content of the aggregation dispersant is preferably 0.01% to 10% by mass, more preferably 0.01% to 8.0% by mass, and still more preferably 0.01% to 6.0% by mass with respect to the total mass of the composition.

The content of the aggregation dispersant is preferably 0.01% to 10% by mass, more preferably 0.01% to 8.0% by mass, and still more preferably 0.01% to 6.0% by mass with respect to the total solid content of the composition.

### <Inorganic Rheology Control Agent>

Examples of the inorganic rheology control agent include bentonite, silica, calcium carbonate, and smectite.

From the viewpoint that the effect of the present invention is more excellent, a mass content ratio of the rheology control agent to the organic solvent (Rheology control agent/Organic solvent) in the composition is preferably 0.005 or more and more preferably 0.01 or more. The upper limit value thereof is not particularly limited, but is preferably 0.20 or less, more preferably 0.10 or less, and still more preferably 0.08 or less.

### [Organic Solvent]

The composition preferably contains an organic solvent.

A type of the organic solvent is not particularly limited, and examples thereof include an ester-based solvent (preferably, an acetate-based solvent), a ketone-based solvent, an alcohol-based solvent, an amide-based solvent, an ether-based solvent, and a hydrocarbon-based solvent.

The organic solvent may be used alone, or in combination of two or more kinds thereof.

A lower limit value of a boiling point of the organic solvent is preferably 55° C. or higher, and from the viewpoint that the effect of the present invention is more excellent, it is more preferably 80° C. or higher and still more preferably 100° C. or higher. An upper limit value of the boiling point of the organic solvent is not particularly limited, but is preferably 400° C. or lower, more preferably 250° C. or lower, still more preferably 225° C. or lower, particularly preferably 200° C. or lower, and most preferably 150° C. or lower.

Examples of the organic solvent include acetone (boiling point: 56° C.), methyl ethyl ketone (boiling point: 79.6° C.), ethanol (boiling point: 78.4° C.), cyclohexane (boiling point: 80.8° C.), ethyl acetate (boiling point: 77.1° C.), ethylene dichloride (boiling point: 83.5° C.), tetrahydrofuran (boiling point: 66° C.), cyclohexanone (boiling point: 155.6° C.), toluene (boiling point: 110° C.), ethylene glycol monomethyl ether (boiling point: 124° C.), ethylene glycol monoethyl ether (boiling point: 135° C.), ethylene glycol dimethyl ether (boiling point: 84° C.), propylene glycol monomethyl ether (boiling point: 120° C.), propylene glycol monoethyl ether (boiling point: 132° C.), acetylacetone (boiling point: 140° C.), cyclopentanone (boiling point: 131° C.), ethylene glycol monomethyl ether acetate (boiling point: 144.5° C.), ethylene glycol ethyl ether acetate (boiling point: 145° C.), ethylene glycol monoisopropyl ether (boiling point: 141° C.), diacetone alcohol (boiling point: 166° C.), ethylene glycol monobutyl ether acetate (boiling point: 192° C.), 1,4-butanediol diacetate (“1,4-BDDA”, boiling point: 232° C.), 1,6-hexanediol diacetate (“1,6-HDDA”, boiling point: 260° C.), 1,3-butylene glycol diacetate (“1,3-BGDA”, boiling point: 232° C.), propylene glycol diacetate (“PGDA”, boiling point: 190° C.), glycerol triacetate (boiling point: 260° C.), 3-methoxy-1-propanol (boiling point: 150° C.), 3-methoxy-1-butanol (boiling point: 161° C.), diethylene glycol monomethyl ether (boiling point: 194° C.), diethylene glycol monoethyl ether (boiling point: 202° C.), diethylene glycol dimethyl ether (boiling point: 162° C.), diethylene glycol diethyl ether (boiling point: 188° C.), propylene glycol monomethyl ether acetate (“PGMEA”, boiling point: 146° C.), propylene glycol monoethyl ether acetate (boiling point: 146° C.), N,N-dimethylformamide (boiling point: 153° C.), dimethyl sulfoxide (boiling point: 189° C.), γ-butyrolactone (boiling point: 204° C.), ethyl acetate (boiling point: 77.1° C.), butyl acetate (boiling point: 126° C.), methyl lactate (boiling point: 144° C.), N-methyl-2-pyrrolidone (boiling point: 202° C.), and ethyl lactate (boiling point: 154° C.).

### [Curing Agent]

The composition may contain a curing agent.

Examples of the curing agent include a phenol-based curing agent, a naphthol-based curing agent, an acid anhydride-based curing agent, an active ester-based curing agent, a benzoxazine-based curing agent, a cyanate ester-based curing agent, a carbodiimide-based curing agent, and an amine adduct-based curing agent.

The curing agent may be used alone or in combination of two or more kinds thereof.

Specific examples of the phenol-based curing agent and the naphthol-based curing agent include “MEH-7700”, “MEH-7810”, and “MEH-7851” manufactured by MEIWA PLASTIC INDUSTRIES, LTD.; “NHN”, “CBN”, and “GPH” manufactured by Nippon Kayaku Co., Ltd.; “SN-170”, “SN-180”, “SN-190”, “SN-475”, “SN-485”, “SN-495”, “SN-375”, and “SN-395” manufactured by NIPPON STEEL Chemical & Material Co., Ltd.; and “LA-7052”, “LA-7054”, “LA-3018”, “LA-3018-50P”, “LA-1356”, “TD2090”, and “TD-2090-60M” manufactured by DIC Corporation.

Examples of the acid anhydride-based curing agent include a curing agent having one or more acid anhydride groups in one molecule.

Specific examples of the acid anhydride-based curing agent include phthalic anhydride, tetrahydrophthalic anhydride, hexahydrophthalic anhydride, methyl tetrahydrophthalic anhydride, methyl hexahydrophthalic anhydride, methyl nadic anhydride, hydrogenated methyl nadic anhydride, trialkyltetrahydrophthalic anhydride, dodecenyl succinic anhydride, 5-(2,5-dioxotetrahydro-3-furanyl)-3-methyl-3-cyclohexene-1,2-dicarboxylic anhydride, trimellitic anhydride, pyromellitic anhydride, benzophenone tetracarboxylic dianhydride, biphenyltetracarboxylic acid dianhydride, naphthalene tetracarboxylic dianhydride, oxydiphthalic dianhydride, 3,3′-4,4′-diphenylsulfone tetracarboxylic dianhydride, 1,3,3a,4,5,9b-hexahydro-5-(tetrahydro-2,5-dioxo-3-furanyl)-naphtho[1,2-C]furan-1,3-dione, ethylene glycol bis(anhydrotrimellitate), and a polymer-type acid anhydride such as styrene maleic acid resin formed by copolymerization of styrene and maleic acid.

Examples of a commercially available product of the acid anhydride-based curing agent include “HNA-100”, “MH-700”, “MTA-15”, “DDSA”, “HF-08”, and “OSA” manufactured by New Japan Chemical Co., Ltd.; “YH306” and “YH307” manufactured by Mitsubishi Chemical Corporation.; “H-TMAn” manufactured by MITSUBISHI GAS CHEMICAL COMPANY, INC.; and “HN-2200”, “HN-2000”, “HN-5500” and “MHAC-P” manufactured by Hitachi Chemical Co., Ltd.

As the active ester-based curing agent, compounds having three or more ester groups with high reaction activity in one molecule, such as phenol esters, thiophenol esters, N-hydroxyamine esters, and esters of heterocyclic hydroxy compounds, are preferably used.

As the active ester-based curing agent, an active ester compound including a dicyclopentadiene-type diphenol structure, an active ester compound including a naphthalene structure, an active ester compound including acetylated phenol novolac, or an active ester compound including a benzoylated phenol novolac is preferable. “Dicyclopentadiene-type diphenol structure” represents a divalent structural unit consisting of phenylene-dicyclopentalene-phenylene.

Examples of a commercially available product of the active ester-based curing agents include active ester compounds including a dicyclopentadiene-type diphenol structure, such as “EXB9451”, “EXB9460”, “EXB9460S”, “HPC-8000”, “HPC-8000H”, “HPC-8000-65T”, “HPC-8000H-65TM”, “EXB-8000L”, and “EXB-8000L-65TM” (manufactured by DIC Corporation); active ester compounds including a naphthalene structure, such as “EXB9416-70BK” and “EXB-8150-65T” (manufactured by DIC Corporation); active ester compounds including acetylated phenol novolac, such as “DC808” (manufactured by Mitsubishi Chemical Corporation.); active ester compounds including benzoylated phenol novolac, such as “YLH1026” (manufactured by Mitsubishi Chemical Corporation.); active ester-based curing agents which are acetylated phenol novolac, such as “DC808” (manufactured by Mitsubishi Chemical Corporation.); and active ester-based curing agents which are benzoylated phenol novolac, such as “YLH1026” (manufactured by Mitsubishi Chemical Corporation.), “YLH1030” (manufactured by Mitsubishi Chemical Corporation.), and “YLH1048” (manufactured by Mitsubishi Chemical Corporation.).

Specific examples of the benzoxazine-based curing agent include “JBZ-OP100D” and “ODA-BOZ” manufactured by JFE Chemical Corporation; “HFB2006M” manufactured by Showa High Polymer Co., Ltd.; and “P-d” and “F-a” manufactured by SHIKOKU CHEMICALS CORPORATION.

Specific examples of the cyanate ester-based curing agent include “PT30” and “PT60” (both of which are phenol novolac-type polyfunctional cyanate ester resins) manufactured by Lonza Japan Ltd.; and “BA230” and “BA230S75” (prepolymers in which some or all of bisphenol A dicyanate molecules are triazinated and form a trimer).

Specific examples of the carbodiimide-based curing agent include “V-03” and “V-07” manufactured by Nisshinbo Chemical Inc.

Examples of a commercially available products of the amine adduct-type curing agent include AMICURE PN-23 and PN-50 (both of which are manufactured by Ajinomoto Fine-Techno Co., Inc.).

In a case where the composition contains the curing agent, as a ratio of the content of the specific binder and the content of the curing agent, an equivalent ratio of the epoxy group and the oxetanyl group in the specific binder to the reactive group in the curing agent (active hydrogen group such as a hydroxyl group in the curing agent) (“Total number of epoxy group and oxetanyl group”/“Number of reactive groups”) is preferably 30/70 to 70/30, more preferably 40/60 to 60/40, and still more preferably 45/55 to 55/45.

A content of the curing agent is preferably 0.001% to 3.5% by mass and more preferably 0.01% to 3.5% by mass with respect to the total mass of the composition.

The content of the curing agent is preferably 0.001% to 3.5% by mass and more preferably 0.01% to 3.5% by mass with respect to the total solid content of the composition.

### [Curing Accelerator]

The composition may contain a curing accelerator.

Examples of the curing accelerator include triphenylphosphine, methyltributylphosphonium dimethyl phosphate, tris-ortho-tolylphosphine, and a boron trifluoride amine complex. Examples of a commercially available product of the phosphate-based curing accelerator include HISHICOLIN PX-4MP (manufactured by Nippon Chemical Industrial CO., LTD.).

In addition, examples of the curing accelerator also include imidazole-based curing accelerators such as 2-methylimidazole (trade name; 2MZ), 2-undecylimidazole (trade name; C11-Z), 2-heptadecylimidazole (trade name; C17Z), 1,2-dimethylimidazole (trade name; 1.2 DMZ), 2-ethyl-4-methylimidazole (trade name; 2E4MZ), 2-phenylimidazole (trade name; 2PZ), 2-phenyl-4-methylimidazole (trade name; 2P4MZ), 1-benzyl-2-methylimidazole (trade name; 1B2MZ), 1-benzyl-2-phenylimidazole (trade name; 1B2PZ), 1-cyanoethyl-2-methylimidazole (trade name; 2MZ-CN), 1-cyanoethyl-2-undecylimidazole (trade name; C11Z-CN), 1-cyanoethyl-2-phenylimidazolium trimellitate (trade name; 2PZCNS-PW), 2,4-diamino-6-[2′-methylimidazolyl-(1′)]-ethyl-s-triazine (trade name; 2MZ-A), 2,4-diamino-6-[2′-undecylimidazolyl-(1′)]-ethyl-s-triazine (trade name; C11Z-A), 2,4-diamino-6-[2′-ethyl-4′-methylimidazolyl-(1′)]-ethyl-s-triazine (trade name; 2E4MZ-A), 2,4-diamino-6-[2′-methylimidazolyl-(1′)]-ethyl-s-triazine isocyanuric acid adduct (trade name; 2MA-OK), 2-phenyl-4,5-dihydroxymethylimidazole (trade name; 2PHZ-PW), 2-phenyl-4-methyl-5-hydroxymethylimidazole (trade name; 2P4MHZ-PW), 1-cyanoethyl-2-phenylimidazole (trade name; 2PZ-CN), 2,4-diamino-6-[2′-methylimidazolyl-(1′)]-ethyl-s-triazine (trade name; 2MZA-PW), and 2,4-diamino-6-[2′-methylimidazolyl-(1′)]-ethyl-s-triazine isocyanuric acid adduct (trade name: 2MAOK-PW) (all manufactured by SHIKOKU CHEMICALS CORPORATION.). Furthermore, examples of the triarylphosphine-based curing accelerator also include compounds described in paragraph 0052 of JP2004-43405A. Examples of the phosphorus-based curing accelerator obtained by adding triphenylborane to triarylphosphine also include compounds described in paragraph 0024 of JP2014-5382A.

A content of the curing accelerator is preferably 0.0002% to 3.0% by mass, more preferably 0.002% to 2.0% by mass, and still more preferably 0.01% to 1.0% by mass with respect to the total mass of the composition.

The content of the curing accelerator is preferably 0.0002% to 3.0% by mass, more preferably 0.002% to 2.0% by mass, and still more preferably 0.02% to 1.0% by mass with respect to the total solid content of the composition.

### [Other Optional Components]

The composition may further contain optional components other than the above-described components. Examples thereof include a sensitizer, a co-sensitizer, a plasticizer, a diluent, an oil sensitizing agent, a filler, a surfactant, an adhesion aid, a rubber component, and the like, and known additives such as auxiliary agents (for example, an antifoaming agent, a flame retardant, a leveling agent, a peeling accelerator, an antioxidant, a fragrance, a surface tension adjuster, a chain transfer agent, and the like) may be added as necessary.

### [Physical Properties of Composition]

In a case where a rotation speed (shear rate) of a rheometer is 0.1 (1/s), from the viewpoint of more excellent sedimentation stabilization of the magnetic particles, a viscosity of the composition at 23° C. is preferably 1 to 10,000 Pa·s, more preferably 1 to 5,000 Pa·s, and still more preferably 1 to 1,000 Pa·s. Here, the viscosity of the composition at 23° C. can be measured by MCR-102 (manufactured by Anton Paar GmbH).

### [Method for Producing Composition]

The composition can be prepared by mixing the respective components described above by known mixing methods (for example, mixing methods using a stirrer, a kneader, a homogenizer, a high-pressure emulsification device, a wet-type pulverizer, a wet-type disperser, or the like).

In a case of preparing the composition, the respective components may be formulated at once, or each of the components may be dissolved or dispersed in a solvent and then sequentially formulated. In addition, the input order and the operation conditions during the formulation are not particularly limited. For example, in a case where two or more other resins are used, the resins may be mixed together at once, or each resin may be mixed in batches.

### [Applications]

The composition can be suitably used as a hole-filling composition for a hole portion such as a via hole and a through-hole, provided on a substrate. Examples of one specific procedure for filling holes include a method including the following steps 1 to 3.
Step 1: step of coating a substrate provided with a hole portion such as a via hole and a through-hole with the composition by a known coating method such as a slit coating method, an ink jet method, a spin coating method, a cast coating method, a roll coating method or a screen printing method such that the hole portion is filled with the composition
Step 2: step of heating the composition in the substrate undergone the step 1 at approximately 120° C. to 180° C. for approximately 30 to 90 minutes such that thermosetting components in the composition are cured
Step 3: step of removing unnecessary portions of the magnetic material obtained in the step 2 sticking out of a surface of the substrate by physical polishing such that the substrate has a flat surface

The circuit board including the above-described magnetic material is suitably used, for example, as an electronic component such as an antenna or an inductor provided in an electronic communication device or the like.

In addition, it is also preferable that the composition is formed into a film shape.

From the viewpoint of more excellent magnetic permeability, a film thickness of the film formed of the composition is preferably 1 to 10,000 μm, more preferably 10 to 1,000 μm, and still more preferably 15 to 800 μm.

The film formed of the composition is suitably used, for example, as an electronic component such as an antenna or an inductor provided in an electronic communication device or the like.

### [Magnetic Material]

The magnetic material (magnetic particle-containing material) according to the embodiment of the present invention is formed of the above-described composition. The magnetic material includes a cured product of the specific binder.

A shape of the magnetic material is not particularly limited, and may be, for example, a shape suitable for the shape of the hole portion provided in the substrate or a film shape as described above.

As an example of a specific aspect of a method for manufacturing the magnetic material, a method for manufacturing the magnetic material in a case where the composition is applied as a hole-filling composition has been described in the above section, but hereinafter, as another example of the specific aspect, an example of a method for manufacturing a film-like magnetic material (hereinafter, also referred to as “magnetic particle-containing film”) will be described.

### (Method for Manufacturing Magnetic Particle-Containing Film)

The magnetic particle-containing film is formed of the above-described composition.

The method for manufacturing the magnetic particle-containing film is not particularly limited, and is preferably a manufacturing method including the following steps.
Composition layer forming step
Curing Step

In the composition layer forming step, the composition is applied onto a substrate (support) or the like to form a layer (composition layer) of the composition. As the substrate, for example, a wiring board having an antenna unit or an inductor unit can be used.

As a method of applying the composition onto the substrate, various coating methods such as a slit coating method, an ink jet method, a spin coating method, a cast coating method, a roll coating method, and a screen printing method can be adopted. A film thickness of the composition layer is preferably 1 to 10,000 μm, more preferably 10 to 1,000 μm, and still more preferably 15 to 800 μm. The composition layer applied onto the substrate may be heated (pre-baked), and the pre-baking is performed, for example, with a hot plate, an oven, or the like at a temperature of 50° C. to 140° C. for 10 to 1800 seconds.

The curing step is not particularly limited as long as the composition layer can be cured, and examples thereof include a heating treatment for heating the composition layer and an exposure treatment for irradiating the composition layer with an actinic ray or radiation.

In a case where the heating treatment is performed, the heating treatment can be performed continuously or batchwise using a heating unit such as a hot plate, a convection oven (hot air circulation dryer), and a high-frequency heater.

A heating temperature in the heating treatment is preferably 120° C. to 260° C. and more preferably 150° C. to 240° C. A heating time is not particularly limited, but is preferably 10 to 1800 seconds.

The pre-baking in the composition layer forming step may also serve as the heating treatment in the curing step.

### [Electronic Component]

The electronic component according to the embodiment of the present invention includes the above-described magnetic material. That is, the electronic component according to the embodiment of the present invention may include the above-described magnetic material as a part of the component. Examples of the electronic component include an inductor and an antenna. As the electronic component, an electronic component having a known structure can be used.

### EXAMPLES

Hereinafter, the present invention will be described in more detail with reference to Examples. The materials, the amounts of materials used, the proportions, the treatment details, the treatment procedure, and the like shown in Examples below may be appropriately modified as long as the modifications do not depart from the spirit of the present invention. Therefore, the scope of the present invention should not be construed as being limited to Examples.

In the following description, unless otherwise specified, “%” means “% by mass” and “part” means “part by mass”.

### [Various Components Used for Preparing Composition]

Respective components described in Table 1 were prepared in for preparing a composition. Each component described in Table 1 is shown below.

### [Magnetic Particles]

P-1: FeMn-based ferrite 1 (concentration of solid contents: 100% by mass, volume-average particle diameter: 40 μm)
P-2: FeMn-based ferrite 2 (concentration of solid contents: 100% by mass, volume-average particle diameter: 20 μm)
P-3: FeMn-based ferrite 3 (concentration of solid contents: 100% by mass, volume-average particle diameter: 10 μm)
P-4: NiZn-based ferrite 1 (concentration of solid contents: 100% by mass, volume-average particle diameter: 40 μm)
P-5: NiZn-based ferrite 2 (concentration of solid contents: 100% by mass, volume-average particle diameter: 20 μm)
P-6: NiZn-based ferrite 3 (concentration of solid contents: 100% by mass, volume-average particle diameter: 5 μm)
P-7: MnZn-based ferrite 1 (concentration of solid contents: 100% by mass, volume-average particle diameter: 40 μm)
P-8: MnZn-based ferrite 2 (concentration of solid contents: 100% by mass, volume-average particle diameter: 20 μm)
P-9: MnZn-based ferrite 3 (concentration of solid contents: 100% by mass, volume-average particle diameter: 5 μm)
P-10: product name “AW2-08 PF-3F” (Fe-based amorphous alloy particles, manufactured by Epson Atmix Corporation, concentration of solid contents: 100% by mass, volume-average particle diameter: 3 μm)
P-11: product name “80% Ni-4Mo PF-5F” (Ni-based alloy particles, manufactured by Epson Atmix Corporation, concentration of solid contents: 100% by mass, volume-average particle diameter: 5 μm)
P-12: product name “ATFINENCI PF3FA” (Fe-based alloy particles, manufactured by Epson Atmix Corporation, concentration of solid contents: 100% by mass, volume-average particle diameter: 3 μm)
P-13: product name “EA-SMP-10 PF-5F” (FeSiCr alloy particles, manufactured by Epson Atmix Corporation, concentration of solid contents: 100% by mass, volume-average particle diameter: 4 μm)
P-14: product name “KUAMET6B2-53 μm” (Fe-based amorphous alloy particles, manufactured by Epson Atmix Corporation, concentration of solid contents: 100% by mass, volume-average particle diameter: 24 μm)

### [Additive 1]

Various components shown in the column of additive 1 are as follows.

### <Rheology Control Agent>

B-1: product name “FLOWNON RCM-100” (fatty acid ester/aromatic ester, manufactured by KYOEISHA CHEMICAL CO., LTD., concentration of solid contents: 100% by mass)
B-2: product name “Talen VA705B” (higher fatty acid amide, manufactured by KYOEISHA CHEMICAL CO., LTD., concentration of solid contents: 100% by mass)

### <Dispersant>

B-3: product name “Disperbyk 111” (acidic dispersant, manufactured by BYK-Chemie GmbH, concentration of solid contents: 100% by mass)
B-4: compound shown below (weight-average molecular weight: 10,000) (basic dispersant, synthetic product, concentration of solid contents: 30% by mass (PGMEA solution)); a numerical value attached to each repeating unit of the main chain represents a mass ratio, and a numerical value attached to the side chain represents a repetition number

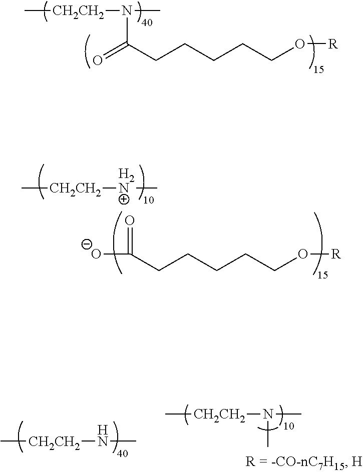

<Epoxy Compound and/or Oxetane Compound>
B-5: product name “EHPE 3150” (1,2-epoxy-4-(2-oxiranyl)cyclohexane adduct of 2,2-bis(hydroxymethyl)-1-butanol, manufactured by Daicel Corporation, concentration of solid contents: 100% by mass)
B-6: product name “CELLOXIDE 2021P” (3′,4′-epoxycyclohexylmethyl 3,4-epoxycyclohexanecarboxylate, manufactured by Daicel Corporation, concentration of solid contents: 100% by mass)
B-7: product name “DENACOL EX-314” (glycerol polyglycidyl ether, manufactured by Nagase ChemteX Corporation, concentration of solid contents: 100% by mass)
B-8: product name “DENACOL EX-512” (polyglycerol polyglycidyl ether, manufactured by Nagase ChemteX Corporation, concentration of solid contents: 100% by mass)
B-9: product name “ZX1059” (mixture of bisphenol A-type epoxy resin and bisphenol F-type epoxy resin, manufactured by NIPPON STEEL Chemical & Material Co., Ltd., concentration of solid contents: 100% by mass)
B-10: product name “HP-4700” (naphthalene-type tetrafunctional epoxy resin, manufactured by DIC Corporation, concentration of solid contents: 100% by mass)
B-13: product name “828US” (bisphenol A-type epoxy resin, manufactured by Mitsubishi Chemical Corporation, concentration of solid contents: 100% by mass)

### <Other Resins>

B-11: product name “YX7553 BH30” (phenoxy resin, manufactured by Mitsubishi Chemical Corporation, concentration of solid contents: 30% by mass, dilution solvent: MEK/cyclohexanone)
B-12: product name “KS-1” (polyvinyl acetal resin, manufactured by SEKISUI CHEMICAL CO., LTD., concentration of solid contents: 100% by mass)

### [Additive 2]

Various components shown in the column of additive 2 are as follows.

### <Curing Agent/Curing Accelerator>

A-1: product name “HISHICOLIN PX-4MP” (phosphate-based epoxy curing accelerator, manufactured by Nippon Chemical Industrial CO., LTD., concentration of solid contents: 100% by mass)
A-2: product name “LA-7054” (novolac-type phenol resin curing agent, manufactured by DIC Corporation, concentration of solid contents: 60% by mass, dilution solvent: MEK)
A-3: product name “2E4MZ” (2-ethyl-4-methylimidazole (curing accelerator), manufactured by SHIKOKU CHEMICALS CORPORATION., concentration of solid contents: 100% by mass)
A-6: product name “HNA-100” (acid anhydride-based curing agent, manufactured by New Japan Chemical Co., Ltd., concentration of solid contents: 100% by mass)

### <Filler>

A-4: product name “SO—C2” (silica particles, manufactured by Admatechs., concentration of solid contents: 100% by mass)
A-5: product name “KBM-573” (N-phenyl-3-aminopropyltrimethoxysilane, manufactured by Shin-Etsu Chemical Co., Ltd., concentration of solid contents: 100% by mass)

### <Heterocyclic Ring-Containing Compound>

AN-1: “2-mercaptobenzimidazole” (HSP-p=8.5 MPa^{1/2}, HSP-h=8.3 MPa^{1/2}, manufactured by Tokyo Chemical Industry Co., Ltd., concentration of solid contents: 100% by mass)
AN-2: “1H-benzotriazole” (HSP-p=12.4 MPa^{1/2}, HSP-h=9.0 MPa^{1/2}, manufactured by Tokyo Chemical Industry Co., Ltd., concentration of solid contents: 100% by mass)
AN-3: “2,1,3-benzothiadiazole” (HSP-p=9.1 MPa^{1/2}, HSP-h=7.1 MPa^{1/2}, manufactured by Tokyo Chemical Industry Co., Ltd., concentration of solid contents: 100% by mass)
AN-4: “2-methylbenzoxazole” (HSP-p=6.6 MPa^{1/2}, HSP-h=4.5 MPa^{1/2} manufactured by Tokyo Chemical Industry Co., Ltd., concentration of solid contents: 100% by mass)
AN-5: “5-benzimidazolecarboxylic acid” (HSP-p=11.3 MPa^{1/2}, HSP-h=12.9 MPa^{1/2} manufactured by Tokyo Chemical Industry Co., Ltd., concentration of solid contents: 100% by mass)

### [Solvent]

S-1: PGMEA (propylene glycol monomethyl ether acetate, manufactured by Tokyo Chemical Industry Co., Ltd.)
S-2: 1,6-HDDA (1,6-hexanediol diacetate, manufactured by Daicel Corporation)
S-3: glycerol triacetate (manufactured by FUJIFILM Wako Pure Chemical Corporation)
S-4: cyclohexanone (manufactured by FUJIFILM Wako Pure Chemical Corporation)
   [Preparation of compositions of Examples and Comparative Examples]

Components described in Table 1, other than the solvent, were mixed to have formulation (parts by mass) shown in Table 1, and the mixture was put into an airtight container made of polytetrafluoroethylene (PTFE). Subsequently, the solvent was added thereto to have formulation (parts by mass) shown in Table 1, the container was sealed, and the mixture was dispersed at 50 G for 1 hour using a low frequency resonance acoustic mixer (RAM) manufactured by Resodyn Acoustic Mixers, Inc., thereby preparing compositions of Examples and Comparative Examples.

### [Evaluation]

### [Magnetic Permeability]

### <Production of Sample Substrate for Measurement>

An Si wafer having a thickness of 100 μm was coated with CT4000 (manufactured by FUJIFILM Electronic Materials Co., Ltd.) to produce a substrate.

The obtained substrate was coated with each of the compositions of Examples and Comparative Examples using an applicator having a gap of 100 μm, thereby obtaining a coating film. Next, the obtained coating film was dried by heating under drying conditions of 100° C. for 120 seconds, and then heated at 230° C. for 15 minutes, thereby producing a substrate with a cured film.

Next, the obtained substrate with a cured film was cut into pieces having a size of 1 cm×2.8 cm, thereby producing a sample substrate for measurement.

Subsequently, using PER-01 (manufactured by KEYCOM Corp., high-frequency magnetic permeability measuring device), magnetic properties (a relative magnetic permeability (μ′A) at 60 MHz) of the film in each of the obtained sample substrates for measurement were measured. From the viewpoint of practicality, the evaluation result is preferably “3” or more, and more preferably “4”. The results are shown in Table 1.

### <Evaluation Standard>

“5”: 20<μ′A
“4”: 17<μ′A≤20
“3”: 15<μ′A≤17
“2”: 10<μ′A≤15
“1”: μ′A≤10

### [HAST Resistance (Moisture Resistance)]

A substrate with a cured film was produced by the same procedure as in <Production of sample substrate for measurement> of [Magnetic permeability] described above.

Next, a high accelerated stress test (HAST) was carried out on the obtained substrate with a cured film. The HAST test was carried out using a moisture resistance tester (HASTEST MODEL 304R8, manufactured by HIRAYAMA Manufacturing Corporation), and test conditions were set to 250 hours under conditions of a temperature of 130° C. and a humidity of 85%.

After the test was completed, using PER-01 (manufactured by KEYCOM Corp., high-frequency magnetic permeability measuring device), magnetic properties (a relative magnetic permeability (μ′B) at 60 MHz) of the film in each of the sample substrates for measurement after the HAST test were measured.

Next, Δμ′ was obtained by the following expression (2), and the obtained value was used as an indicator of deterioration of the magnetic particles by the HAST test. From the viewpoint of practicality, the evaluation result is preferably “2” or more, and more preferably “3”. The results are shown in Table 1.

Δμ′=1−μ′B/μ′A Expression (2):

### <Evaluation Standard>

“3”: Δμ′≤0.01
“2”: 0.01<Δμ′≤0.1
“1”: 0.1<Δμ′, or the deterioration of the film could not be measured significantly.

Table 1 is shown below.

“Proportion of particles having particle diameter of 10 μm or less (% by volume)” in Table 1 indicates the content (% by volume) of the magnetic particles having a particle diameter of 10 μm or less with respect to the total volume of the magnetic particles. The measuring method of the proportion (% by volume) of the particles having a particle diameter of 10 μm or less is as described above.

TABLE 1

| | Magnetic particles | | Additive 1 | | Additive 2 | | Organic solvent | | Proportion of | | |
|---|---|---|---|---|---|---|---|---|---|---|---|
| | | Blending | | Blending | | Blending | | Blending | particles having | | |
| | | amount | | amount | | amount | | amount | particle diameter of | Evaluation result | |
| Table 1 | | (part by | | (part by | | (part by | | (part by | 10 μm or less | Magnetic | Moisture |
| (1) | Type | mass) | Type | mass) | Type | mass) | Type | mass) | (% by volume) | permeability | resistance |
| Example 1 | P-1 | 42.8 | B-1 | 0.3 | AN-1 | 0.46 | S-1 | 6.6 | 51% | 5 | 2 |
| | P-10 | 42.8 | B-4 | 1.99 | | | | | | | |
| | | | B-8 | 5.08 | | | | | | | |
| Example 2 | P-1 | 42.8 | B-1 | 0.3 | AN-2 | 0.46 | S-1 | 6.6 | 51% | 4 | 3 |
| | P-10 | 42.8 | B-4 | 1.99 | | | | | | | |
| | | | B-8 | 5.08 | | | | | | | |
| Example 3 | P-1 | 42.8 | B-1 | 0.3 | AN-3 | 0.46 | S-1 | 6.6 | 51% | 5 | 3 |
| | P-10 | 42.8 | B-4 | 1.99 | | | | | | | |
| | | | B-8 | 5.08 | | | | | | | |
| Example 4 | P-1 | 42.8 | B-1 | 0.32 | AN-2 | 0.09 | S-1 | 6.5 | 51% | 5 | 2 |
| | P-10 | 42.8 | B-4 | 2.12 | | | | | | | |
| | | | B-8 | 5.4 | | | | | | | |
| Example 5 | P-1 | 42.8 | B-1 | 0.31 | AN-2 | 0.23 | S-1 | 6.5 | 51% | 5 | 3 |
| | P-10 | 42.8 | B-4 | 2.07 | | | | | | | |
| | | | B-8 | 5.28 | | | | | | | |
| Example 6 | P-1 | 42.8 | B-1 | 0.29 | AN-2 | 0.69 | S-1 | 6.6 | 51% | 4 | 3 |
| | P-10 | 42.8 | B-4 | 1.92 | | | | | | | |
| | | | B-8 | 4.89 | | | | | | | |
| Example 7 | P-1 | 42.8 | B-1 | 0.3 | AN-1 | 0.23 | S-1 | 6.6 | 51% | 4 | 3 |
| | P-10 | 42.8 | B-4 | 1.99 | AN-2 | 0.23 | | | | | |
| | | | B-8 | 5.08 | | | | | | | |
| Example 8 | P-2 | 42.8 | B-1 | 0.31 | AN-2 | 0.23 | S-2 | 6.5 | 55% | 4 | 3 |
| | P-10 | 42.8 | B-4 | 2.07 | | | | | | | |
| | | | B-8 | 5.28 | | | | | | | |
| Example 9 | P-3 | 42.8 | B-1 | 0.31 | AN-2 | 0.23 | S-3 | 6.5 | 82% | 3 | 3 |
| | P-10 | 42.8 | B-4 | 2.07 | | | | | | | |
| | | | B-8 | 5.28 | | | | | | | |
| Example 10 | P-4 | 42.8 | B-1 | 0.31 | AN-2 | 0.23 | S-4 | 6.5 | 51% | 5 | 3 |
| | P-10 | 42.8 | B-4 | 2.07 | | | | | | | |
| | | | B-8 | 5.28 | | | | | | | |

TABLE 2

| | Magnetic particles | | Additive 1 | | Additive 2 | | Organic solvent | | Proportion of | | |
|---|---|---|---|---|---|---|---|---|---|---|---|
| | | Blending | | Blending | | Blending | | Blending | particles having | | |
| | | amount | | amount | | amount | | amount | particle diameter of | Evaluation result | |
| Table 1 | | (part by | | (part by | | (part by | | (part by | 10 μm or less | Magnetic | Moisture |
| (2) | Type | mass) | Type | mass) | Type | mass) | Type | mass) | (% by volume) | permeability | resistance |
| Example 11 | P-5 | 42.8 | B-1 | 0.31 | AN-2 | 0.23 | S-2 | 6.5 | 55% | 4 | 3 |
| | P-10 | 42.8 | B-4 | 2.07 | | | | | | | |
| | | | B-8 | 5.28 | | | | | | | |
| Example 12 | P-6 | 42.8 | B-1 | 0.31 | AN-2 | 0.23 | S-3 | 6.5 | 82% | 3 | 3 |
| | P-10 | 42.8 | B-4 | 2.07 | | | | | | | |
| | | | B-8 | 5.28 | | | | | | | |
| Example 13 | P-7 | 42.8 | B-1 | 0.31 | AN-2 | 0.23 | S-4 | 6.5 | 51% | 5 | 3 |
| | P-10 | 42.8 | B-4 | 2.07 | | | | | | | |
| | | | B-8 | 5.28 | | | | | | | |
| Example 14 | P-8 | 42.8 | B-1 | 0.31 | AN-2 | 0.23 | S-2 | 3.25 | 55% | 4 | 3 |
| | P-10 | 42.8 | B-4 | 2.07 | | | S-1 | 3.25 | | | |
| | | | B-8 | 5.28 | | | | | | | |
| Example 15 | P-9 | 42.8 | B-1 | 0.31 | AN-2 | 0.23 | S-3 | 6.5 | 82% | 3 | 3 |
| | P-10 | 42.8 | B-4 | 2.07 | | | | | | | |
| | | | B-8 | 5.28 | | | | | | | |
| Example 16 | P-2 | 42.8 | B-1 | 0.31 | AN-2 | 0.23 | S-4 | 6.5 | 50% | 5 | 3 |
| | P-11 | 42.8 | B-4 | 2.07 | | | | | | | |
| | | | B-8 | 5.28 | | | | | | | |
| Example 17 | P-2 | 42.8 | B-1 | 0.31 | AN-2 | 0.23 | S-2 | 6.5 | 51% | 5 | 3 |
| | P-12 | 42.8 | B-4 | 2.07 | | | | | | | |
| | | | B-8 | 5.28 | | | | | | | |
| Example 18 | P-2 | 42.8 | B-1 | 0.31 | AN-2 | 0.23 | S-3 | 6.5 | 50% | 5 | 3 |
| | P-13 | 42.8 | B-4 | 2.07 | | | | | | | |
| | | | B-8 | 5.28 | | | | | | | |
| Example 19 | P-14 | 85.6 | B-1 | 0.31 | AN-2 | 0.23 | S-1 | 6.5 | 11% | 3 | 3 |
| | | | B-4 | 2.07 | | | | | | | |
| | | | B-8 | 5.28 | | | | | | | |

TABLE 3

| | Magnetic particles | | Additive 1 | | Additive 2 | | Organic solvent | | Proportion of | | |
|---|---|---|---|---|---|---|---|---|---|---|---|
| | | Blending | | Blending | | Blending | | Blending | particles having | | |
| | | amount | | amount | | amount | | amount | particle diameter of | Evaluation result | |
| Table 1 | | (part by | | (part by | | (part by | | (part by | 10 μm or less | Magnetic | Moisture |
| (3) | Type | mass ) | Type | mass ) | Type | mass) | Type | mass) | (% by volume) | permeability | resistance |
| Example 20 | P-1 | 40.77 | B-1 | 0.75 | AN-2 | 0.25 | S-1 | 0 | 51% | 3 | 2 |
| | P-10 | 40.77 | B-4 | 4.92 | | | | | | | |
| | | | B-8 | 12.54 | | | | | | | |
| Example 21 | P-1 | 41.8 | B-1 | 0.22 | AN-2 | 0.22 | S-1 | 10.7 | 51% | 5 | 3 |
| | P-10 | 41.8 | B-4 | 1.47 | | | | | | | |
| | | | B-8 | 3.74 | | | | | | | |
| Example 22 | P-1 | 28.5 | B-1 | 0.22 | AN-2 | 0.23 | S-1 | 6.7 | 31% | 5 | 3 |
| | P-4 | 28.5 | B-4 | 1.46 | A-1 | 0.46 | | | | | |
| | P-10 | 28.5 | B-8 | 3.71 | A-2 | 0.77 | | | | | |
| | | | | | A-3 | 0.46 | | | | | |
| | | | | | A-4 | 0.23 | | | | | |
| | | | | | A-5 | 0.23 | | | | | |
| Example 24 | P-1 | 42.8 | B-1 | 0.31 | AN-2 | 0.23 | S-1 | 6.5 | 51% | 5 | 3 |
| | P-10 | 42.8 | B-4 | 2.07 | | | | | | | |
| | | | B-5 | 4.04 | | | | | | | |
| | | | B-9 | 0.62 | | | | | | | |
| | | | B-10 | 0.62 | | | | | | | |
| Example 25 | P-1 | 42.8 | B-1 | 0.31 | AN-2 | 0.23 | S-1 | 5.1 | 51% | 4 | 3 |
| | P-10 | 42.8 | B-4 | 2.07 | | | | | | | |
| | | | B-6 | 4.04 | | | | | | | |
| | | | B-11 | 2.07 | | | | | | | |
| | | | B-12 | 0.62 | | | | | | | |
| Example 26 | P-1 | 42.8 | B-1 | 0.31 | AN-2 | 0.23 | S-1 | 6.5 | 51% | 4 | 3 |
| | P-10 | 42.8 | B-4 | 2.07 | A-6 | 0.62 | | | | | |
| | | | B-7 | 4.04 | | | | | | | |
| | | | B-13 | 0.62 | | | | | | | |
| Example 27 | P-2 | 42.8 | B-2 | 0.31 | AN-2 | 0.23 | S-2 | 8 | 50% | 4 | 3 |
| | P-11 | 42.8 | B-3 | 0.62 | | | | | | | |
| | | | B-8 | 5.28 | | | | | | | |

TABLE 4

| | Magnetic particles | | Additive 1 | | Additive 2 | | Organic solvent | | Proportion of | | |
|---|---|---|---|---|---|---|---|---|---|---|---|
| | | Blending | | Blending | | Blending | | Blending | particles having | | |
| | | amount | | amount | | amount | | amount | particle diameter of | Evaluation result | |
| Table 1 | | (part by | | (part by | | (part by | | (part by | 10 μm or less | Magnetic | Moisture |
| (4) | Type | mass) | Type | mass) | Type | mass) | Type | mass) | (% by volume) | permeability | resistance |
| Comparative | P-1 | 42.8 | B-1 | 0.29 | AN-1 | 0.69 | S-1 | 8 | 51% | 3 | 1 |
| Example 1 | P-10 | 42.8 | B-3 | 5.46 | | | | | | | |
| Comparative | P-1 | 39.1 | B-1 | 0.66 | AN-1 | 0.69 | S-1 | 8 | 51% | 2 | 3 |
| Example 2 | P-10 | 39.1 | B-8 | 12.45 | | | | | | | |
| Comparative | P-1 | 42.8 | B-1 | 0.29 | AN-4 | 0.69 | S-1 | 7.9 | 51% | 3 | 1 |
| Example 3 | P-10 | 42.8 | B-3 | 0.58 | | | | | | | |
| | | | B-8 | 4.89 | | | | | | | |
| Comparative | P-1 | 42.8 | B-1 | 0.29 | AN-5 | 0.69 | S-1 | 7.9 | 51% | 2 | 3 |
| Example 4 | P-10 | 42.8 | B-3 | 0.58 | | | | | | | |
| | | | B-8 | 4.89 | | | | | | | |

From the results in Table 1, it was found that the magnetic material formed from the composition of Examples had a high magnetic permeability and exhibited excellent moisture resistance.

From the comparison of Examples 1 to 3, it was found that, in a case where the polarity element (δP) of the Hansen solubility parameter of the specific heterocyclic ring-containing compound was 9.0 MPa^{1/2} or more, the moisture resistance of the magnetic material formed from the composition was more excellent. In addition, it was found that, in a case where the hydrogen bond element (611) of the Hansen solubility parameter of the specific heterocyclic ring-containing compound was 8.5 MPa^{1/2} or less, the magnetic permeability of the magnetic material formed from the composition was higher.

In addition, from the comparison of Example 2, Example 8, and Example 9, the comparison of Example 10 to Example 12, and the comparison of Example 13 to Example 15, it was found that, in a case where the magnetic particles included the ferrite particles and the alloy particles and the volume-average particle diameter of the ferrite particles was 20 μm or more, the magnetic material formed from the composition exhibited a high magnetic permeability.

In addition, from the comparison of Examples 2 and 4 to 6, it was found that, in a case where the mass content ratio of the specific heterocyclic ring-containing compound to the dispersant (Content of specific heterocyclic ring-containing compound/Content of dispersant) was 0.20 to 0.60, both the magnetic permeability and the moisture resistance of the magnetic material formed from the composition could be compatible at an excellent level.

In addition, from the results of Example 19, it was found that, as the content of the magnetic particles having a particle diameter of 10 μm or less was smaller (in other words, as the content of the magnetic particles having a large surface area was smaller), the moisture resistance of the magnetic material formed from the composition was more excellent.

In addition, from the results of Example 20, it was found that, in a case where the content of the magnetic particles was 90% by mass or more with respect to the total solid content of the composition, the magnetic material formed from the composition exhibited a high magnetic permeability.

In addition, from the comparison of Example 16 and Example 27, it was found that, in a case where the dispersant was the basic dispersant, the magnetic material formed from the composition exhibited a high magnetic permeability.

From the results in Table 1, it was found that the compositions of Comparative Examples did not exhibit the desired effect.

What is claimed is:

1. A composition comprising:
magnetic particles;
a heterocyclic ring-containing compound;
a compound selected from the group consisting of an epoxy compound and an oxetane compound; and
a dispersant,
wherein a polarity element of a Hansen solubility parameter of the heterocyclic ring-containing compound is 8.0 MPa^{1/2} or more, and
a hydrogen bond element of the Hansen solubility parameter of the heterocyclic ring-containing compound is 10.0 MPa^{1/2} or less.

2. The composition according to claim 1,
wherein the dispersant includes a basic dispersant.

3. The composition according to claim 1,
wherein the magnetic particles include alloy particles.

4. The composition according to claim 1,
wherein the magnetic particles include soft magnetic particles.

5. The composition according to claim 1,
wherein the magnetic particles are spherical.

6. The composition according to claim 1,
wherein a content of magnetic particles having a particle diameter of 10 μm or less is 10% by volume or more with respect to a total volume of the magnetic particles.

7. The composition according to claim 1,
wherein the heterocyclic ring-containing compound is a nitrogen-containing ring compound.

8. A magnetic material formed of the composition according to claim 1.

9. An electronic component comprising:
the magnetic material according to claim 8.

10. The electronic component according to claim 9,
wherein the electronic component is used as an inductor.

11. The electronic component according to claim 9,
wherein the electronic component is used as an antenna.

12. The composition according to claim 7,
wherein the magnetic particles include alloy particles.

13. The composition according to claim 7,
wherein the magnetic particles include soft magnetic particles.

14. The composition according to claim 7,
wherein the magnetic particles are spherical.

15. The composition according to claim 7,
wherein a content of magnetic particles having a particle diameter of 10 μm or less is 10% by volume or more with respect to a total volume of the magnetic particles.

16. The composition according to claim 7,
wherein the heterocyclic ring-containing compound is a nitrogen-containing ring compound.

17. A magnetic material formed of the composition according to claim 7.

18. An electronic component comprising:
the magnetic material according to claim 17.

19. The electronic component according to claim 18,
wherein the electronic component is used as an inductor.

20. The electronic component according to claim 18,
wherein the electronic component is used as an antenna.
